(19) United States
(12) Patent Application Publication
(10) Pub. No.: US 2011/0033664 A1
(43) Pub. Date: Feb. 10, 2011

(54) METHOD FOR PRODUCING AN OPTICALLY VARIABLE IMAGE CARRYING SHIM

(75) Inventors: Mark Robert Dicker, Sandown (GB); David R. Boswell, Berks Woodley (GB); Steven Winton, Old Windsor (GB); Katia Studer, Rixheim (FR); Sebastien Villeneuve, Huningue (FR); Bruno Spony, Wahlbach (FR)

Correspondence Address: BASF Corporation;Patent Department, 500 White Plains Road, P.O. Box 2005, Tarrytown, NY, 10591, US

(73) Assignee: BASF SE, LUGWIGSHAFEN (DE)

(21) Appl. No.: 12/740,115

(22) PCT Filed: Nov. 5, 2008
(86) PCT No.: PCT/EP08/64968

§ 371 Date: Oct. 29, 2010

(30) Foreign Application Priority Data
Nov. 15, 2007 (EP) 2007/062377
Apr. 28, 2008 (EP) 08155268.9

(51) Int. Cl. D06N 7/04; C08L 43/04; B29C 59/02

(52) U.S. Cl. 428/142; 524/547; 427/510; 425/385; 264/293

(57) ABSTRACT

The present invention relates to a method for producing a duplicated shim and the duplicated shim obtainable by the method. The duplicated (UV-cured) shim, independent of any carrying device (like a cylinder or belt), can be applied directly to the surface of the transfer roller (and impart the surface OVD structure into a clear lacquer) in a similar way to conventional nickel shims.

The present invention relates to a method for producing a duplicated shim and the duplicated shim obtainable by the method. The duplicated (UV-cured) shim, independent of any carrying device (like a cylinder or belt), can be applied directly to the surface of the transfer roller (and impart the surface OVD structure into a clear lacquer) in a similar way to conventional nickel shims.

Surface relief OVD (Optically Variable Devices) including holographic shims are usually prepared by electroforming. Electroforming is an electro-chemical process of metal fabrication achieved by depositing metal, particularly nickel on an electrically conductive mandrel, particularly a photo resist coated glass plate containing OVD sub-microscopic structures like but not limited to holograms and the like.

Electroforming has been in production since the 1850's. Basically, it is an electroplating process in which the substrate plated into is separated from the plated portion, the substrate or mandrel can be either reused or discarded.

In its most basic form, electroforming is carried out in a tank that is filled with a sulfamate nickel plating solution (electrolyte). In the tank there are a minimum of two items—a cathode and an anode. External to the tank is a direct current source which has its positive current output connected to the anode in the tank and its negative terminal connected to the cathode (work) position. A rectifier supplies the direct current source, when put into operation. The current flow is along the positive leads through the anode, through the solution to the cathode and then back to the source. This flow causes a metallic deposit consisting of microscopically small particles and accumulated on the mandrel, which is the cathode in the same male/female relationship that exists between a mould and a cast piece. Depending upon the production requirements, the mandrel can be used to produce the finished part directly or it may be used to produce intermediate mandrels.

Because of its excellent reproduction of even the minutest detail, electroforming is used to produce phonographic records, OVD holographic shims, video discs etc. It is without doubt one of the finest reproduction methods available for many precision applications including OVDs (Optically Variable Devices) like holograms, kinegrams, direct write imaging, dot matrix, three dimensional imagery and the like.

In the production of OVDs, at the conclusion of preparing a photo resist master, the holographer is left with a glass plate with a sub-microscopic image etched on the surface of a fragile positive reading photo resist coating. This coated glass cannot obviously be used to transfer the encoded imagery by means of embossing or optical transfer into other substrates.

The electroforming process is used to perform the conversion from the photo resist master to nickel plates and subsequent shims for mass production.

All electroforming begins with a mandrel. From this mandrel an electroform is made by electro deposition. To make the mandrel in this scenario, a resist coated glass master is covered with a thin silver layer to render it conductive and a nickel copy is made from it. Following separation of the nickel plate formed from the silver coated photo resist plate, the nickel master is passivated and further copies are electroformed.

The purpose of the present application is to produce OVD shims by a UV-curing process.

Therefore, it is one object of the present invention to provide a duplicated shim which can be easily released from the original shim as well as from the varnish used to print the hologram.

It is a further object of the present invention to provide a method for producing a seam free transfer cylinder for the production and use of optically variable devices and patterns in printing.

Said objects has been solved by a UV-curable composition having sufficient concentration of UV-reactive functions for use in the production of a duplicated shim, wherein the duplicated shim shows, once cured, a sufficient crosslinking density and polymerization degree higher than 95% (measured by ATR spectroscopy by following the disappearance of the acrylate band at 1410 cm⁻¹), and
a method for producing a duplicated shim comprising the following steps:
(a) coating at least part of a (filmic) substrate with the UV-curable composition (ultra violet curable lacquer) according to any of claims 1 to 4 on its upper surface, especially printing a filmic substrate with the UV-curable composition on its upper surface,
(b) casting (transferring) an optically variable image into at least part of the surface of the UV-curable composition with an original shim having the optically variable image thereon,
(c) imparting the optically variable image into the UV-curable composition and instantly curing; for example via a UV lamp, or electron beam radiation to produce the duplicated shim;
(d) separating the duplicated shim from the original shim, whereby in case the substrate is a cylinder the duplicated shim is obtained; and in case the substrate is a sheet of a (plastic) material the sheet of a (plastic) material is processed to the duplicated shim.

The duplicated shim, obtainable by the above described method forms a further subject of the present invention.

In the process of the present invention a UV-curable formulation is applied onto a substrate, brought in contact with the original shim while being simultaneously exposed to UV-light to generate a duplicated shim showing high mechanical and solvent resistance. This process eliminates the need for nickel hard or soft embossing shims. The duplicated shim can be further used to print OVD as described in WO05/051675 and WO08/061,930. UV-light can be replaced by electron beams.

The duplicated (UV-cured) shim, independent of any carrying device (like a cylinder or belt), can be applied directly to the surface of the transfer roller (and impart the surface OVD structure into a clear lacquer) in a similar way to conventional nickel shims. In other words, the user would have the choice of a nickel shim or a UV-cured shim, the economic advantage of the UV-cured shim may be substantial.

The UV-curable composition used to produce the shim should have a crosslinking density sufficiently high to provide a hard material once properly cured. The curing conditions and the formulation composition have to be set up so that a polymerization degree of at least 95% and a sufficient crosslinking density are obtained. As an example, a concentration of 5 mol double bonds by kg in the case of an acrylate formulation is typically sufficient to allow satisfying crosslinking density.

The UV-curable formulation can be a free radical curable formulation or a cationic curable formulation. To simplify the release, the surface tension of the shim can be modified by adding an additive into the formulation that modifies the surface tension, e.g. a silicone compound or a fluoro compound.

In all cases, UV curing can be replaced by EB curing, thus eliminating the need for a photoinitiator. However, in the case of UV-curing, the filmic substrate has to be transparent to UV-radiation to perform the UV-curing step.

The unsaturated compounds in a free radical UV-curable composition may include one or more olefinic double bonds. They may be of low (monomeric) or high (oligomeric) molecular mass. Examples of monomers containing a double bond are alkyl, hydroxyalkyl or amino acrylates, or alkyl, hydroxyalkyl or amino methacrylates, for example methyl, ethyl, butyl, 2-ethylhexyl or 2-hydroxyethyl acrylate, isobornyl acrylate, methyl methacrylate or ethyl methacrylate. Silicone acrylates are also advantageous. Other examples are acrylonitrile, acrylamide, methacrylamide, N-substituted (meth)acrylamides, vinyl esters such as vinyl acetate, vinyl ethers such as isobutyl vinyl ether, styrene, alkyl- and halostyrenes, N-vinylpyrrolidone, vinyl chloride or vinylidene chloride.

Examples of monomers containing two or more double bonds are the diacrylates of ethylene glycol, propylene glycol, neopentyl glycol, hexamethylene glycol or of bisphenol A, and 4,4′-bis(2-acryl-oyloxyethoxy)diphenylpropane, trimethylolpropane triacrylate, pentaerythritol triacrylate or tetraacrylate, vinyl acrylate, divinylbenzene, divinyl succinate, diallyl phthalate, tri-allyl phosphate, triallyl isocyanurate or tris(2-acryloylethyl)isocyanurate.

Examples of polyunsaturated compounds of relatively high molecular mass (oligomers) are acrylated epoxy resins, polyesters containing acrylate-, vinyl ether- or epoxy-groups, and also polyurethanes and polyethers. Further examples of unsaturated oligomers are unsaturated polyester resins, which are usually prepared from maleic acid, phthalic acid and one or more diols and have molecular weights of from about 500 to 3000. In addition it is also possible to employ vinyl ether monomers and oligomers, and also maleate-terminated oligomers with polyester, polyurethane, polyether, polyvinyl ether and epoxy main chains. Of particular suitability are combinations of oligomers which carry vinyl ether groups and of polymers as described in WO90/01512. However, copolymers of vinyl ether and maleic acid-functionalized monomers are also suitable. Unsaturated oligomers of this kind can also be referred to as prepolymers.

Particularly suitable examples are esters of ethylenically unsaturated carboxylic acids and polyols or polyepoxides, and polymers having ethylenically unsaturated groups in the chain or in side groups, for example unsaturated polyesters, polyamides and polyurethanes and copolymers thereof, polymers and copolymers containing (meth)acrylic groups in side chains, and also mixtures of one or more such polymers.

Examples of unsaturated carboxylic acids are acrylic acid, methacrylic acid, crotonic acid, itaconic acid, cinnamic acid, and unsaturated fatty acids such as linolenic acid or oleic acid. Acrylic and methacrylic acid are preferred.

Suitable polyols are aromatic and, in particular, aliphatic and cycloaliphatic polyols. Examples of aromatic polyols are hydroquinone, 4,4′-dihydroxydiphenyl, 2,2-di(4-hydroxyphenyl)propane, and also novolaks and resols. Examples of polyepoxides are those based on the abovementioned polyols, especially the aromatic polyols, and epichlorohydrin. Other suitable polyols are polymers and copolymers containing hydroxyl groups in the polymer chain or in side groups, examples being polyvinyl alcohol and copolymers thereof or polyhydroxyalkyl methacrylates or copolymers thereof. Further polyols which are suitable are oligoesters having hydroxyl end groups.

Examples of aliphatic and cycloaliphatic polyols are alkylenediols having preferably 2 to 12 C ms, such as ethylene glycol, 1,2- or 1,3-propanediol, 1,2-, 1,3- or 1,4-butanediol, pentanediol, hexanediol, octanediol, dodecanediol, diethylene glycol, triethylene glycol, polyethylene glycols having molecular weights of preferably from 200 to 1500, 1,3-cyclopentanediol, 1,2-, 1,3- or 1,4-cyclohexanediol, 1,4-dihydroxymethylcyclohexane, glycerol, tris(β-hydroxyethyl)amine, trimethylolethane, trimethylolpropane, pentaerythritol, dipentaerythritol and sorbitol.

The polyols may be partially or completely esterified with one carboxylic acid or with different unsaturated carboxylic acids, and in partial esters the free hydroxyl groups may be modified, for example etherified or esterified with other carboxylic acids.

Examples of esters are: trimethylolpropane triacrylate, trimethylolethane triacrylate, trimethylolpropane trimethacrylate, trimethylolethane trimethacrylate, tetramethylene glycol dimethacrylate, triethylene glycol dimethacrylate, tetraethylene glycol diacrylate, pentaerythritol diacrylate, pentaerythritol triacrylate, pentaerythritol tetraacrylate, dipentaerythritol diacrylate, dipentaerythritol triacrylate, dipentaerythritol tetraacrylate, dipentaerythritol pentaacrylate, dipentaerythritol hexaacrylate, tripentaerythritol octaacrylate, pentaerythritol dimethacrylate, pentaerythritol trimethacrylate, dipentaerythritol dimethacrylate, dipentaerythritol tetramethacrylate, tripentaerythritol octamethacrylate, pentaerythritol diitaconate, dipentaerythritol tris-itaconate, dipentaerythritol pentaitaconate, dipentaerythritol hexaitaconate, ethylene glycol diacrylate, 1,3-butanediol diacrylate, 1,3-butanediol dimethacrylate, 1,4-butanediol diitaconate, sorbitol triacrylate, sorbitol tetraacrylate, pentaerythritol-modified triacrylate, sorbitol tetra methacrylate, sorbitol pentaacrylate, sorbitol hexaacrylate, oligoester acrylates and methacrylates, glycerol diacrylate and triacrylate, 1,4-cyclohexane diacrylate, bisacrylates and bismethacrylates of polyethylene glycol with a molecular weight of from 200 to 1500, or mixtures thereof.

Also suitable as polymerizable components are the amides of identical or different, unsaturated carboxylic acids with aromatic, cycloaliphatic and aliphatic polyamines having preferably 2 to 6, especially 2 to 4, amino groups. Examples of such polyamines are ethylenediamine, 1,2- or 1,3-propylenediamine, 1,2-, 1,3- or 1,4-butylenediamine, 1,5-pentylenediamine, 1,6-hexylenediamine, octylenediamine, dodecylenediamine, 1,4-diaminocyclohexane, isophoronediamine, phenylenediamine, bisphenylenediamine, di-β-aminoethyl ether, diethylenetriamine, triethylenetetramine, di(β-aminoethoxy)- or di(β-aminopropoxy)ethane. Other suitable polyamines are polymers and copolymers, preferably with additional amino groups in the side chain, and oligoamides having amino end groups. Examples of such unsaturated amides are methylenebisacrylamide, 1,6-hexamethylenebisacrylamide, diethylenetriaminetrismethacrylamide, bis(methacrylamido-propoxy)ethane, β-methacrylamidoethyl methacrylate and N[(β-hydroxy-ethoxy)ethyl]acrylamide.

Suitable unsaturated polyesters and polyamides are derived, for example, from maleic acid and from diols or diamines. Some of the maleic acid can be replaced by other dicarboxylic acids. They can be used together with ethylenically unsaturated comonomers, for example styrene. The polyesters and polyamides may also be derived from dicarboxylic acids and from ethylenically unsaturated diols or diamines, especially from those with relatively long chains of, for example 6 to 20 C atoms. Examples of polyurethanes are those composed of saturated or unsaturated diisocyanates and of unsaturated or, respectively, saturated diols.

Polymers with (meth)acrylate groups in the side chain are likewise known. They may, for example, be reaction products of epoxy resins based on novolaks with (meth)acrylic acid, or may be homo- or copolymers of vinyl alcohol or hydroxyalkyl derivatives thereof which are esterified with (meth)acrylic acid, or may be homo- and copolymers of (meth)acrylates which are esterified with hydroxyalkyl(meth)acrylates.

Other suitable polymers with acrylate or methacrylate groups in the side chains are, for example, solvent soluble or alkaline soluble polyimide precursors, for example poly(amic acid ester) compounds, having the photopolymerizable side groups either attached to the backbone or to the ester groups in the molecule, i.e. according to EP624826. Such oligomers or polymers can be formulated with optionally reactive diluents, like polyfunctional (meth)acrylates in order to prepare highly sensitive polyimide precursor resists.

Examples of a polymerizable component are also polymers or oligomers having at least two ethylenically unsaturated groups and at least one carboxyl function within the molecule structure, such as a resin obtained by the reaction of a saturated or unsaturated polybasic acid anhydride with a product of the reaction of an epoxy compound and an unsaturated monocarboxylic acid, for example, photosensitive compounds as described in JP 10-301276 and commercial products such as for example EB9696, UCB Chemicals; KAYARAD TCR1025, Nippon Kayaku Co., LTD., NK OLIGO EA-6340, EA-7440 from Shin-Nakamura Chemical Co., Ltd., or an addition product formed between a carboxyl group-containing resin and an unsaturated compound having an α,β-unsaturated double bond and an epoxy group (for example, ACA200M, Daicel Industries, Ltd.). Additional commercial products as examples of polymerizable component are ACA200, ACA210P, ACA230AA, ACA250, ACA300, ACA320 from Daicel Chemical Industries, Ltd.

The photopolymerizable compounds are used alone or in any desired mixtures. It is preferred to use mixtures of polyol (meth)acrylates.

A preferred composition comprises at least one compound having at least one free carboxylic group, said compound being either subject of component (a) or of a binder polymer.

As diluent, a mono- or multi-functional ethylenically unsaturated compound, or mixtures of several of said compounds, can be included in the above composition up to 70% by weight based on the solid portion of the composition.

The invention also provides compositions comprising as polymerizable component at least one ethylenically unsaturated photopolymerizable compound which is emulsified or dissolved in water.

The unsaturated polymerizable components can also be used in admixture with non-photopolymerizable, film-forming components. These may, for example, be physically drying polymers or solutions thereof in organic solvents, for instance nitrocellulose or cellulose acetobutyrate. They may also, however, be chemically and/or thermally curable (heat-curable) resins, examples being polyisocyanates, polyepoxides and melamine resins, as well as polyimide precursors. The use of heat-curable resins at the same time is important for use in systems known as hybrid systems, which in a first stage are photopolymerized and in a second stage are crosslinked by means of thermal aftertreatment.

A photoinitiator is incorporated into the formulation to initiate the UV-curing process. Photoinitiator compounds are for example described by Kurt Dietliker in “A compilation of photoinitiators commercially available for UV today”, Sita Technology Ltd., Edinburgh and London, 2002, and by J. V. Crivello and K Dietliker in “Chemistry & Technology of UV & EB Formulation for Coatings, Inks and Paints; Photoinitiators for Free Radical, Cationic & Anionic Photopolymerization, Ed. 2, Vol. III, 1998, Sita Technology Ltd., London.

In certain cases it may be of advantage to use mixtures of two or more photoinitiators, for example mixtures with camphor quinone; benzophenone, benzophenone derivatives of the formula:

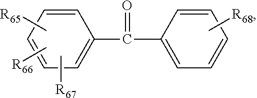

wherein
R₆₅, R₆₆ and R₆₇ independently of one another are hydrogen, C₁-C₄-alkyl, C₁-C₄-halogen-alkyl, C₁-C₄-alkoxy, chlorine or N(C₁-C₄-alkyl)₂;
R₆₈ is hydrogen, C₁-C₄-alkyl, C₁-C₄-halogenalkyl, phenyl, N(C₁-C₄-alkyl)₂, COOCH₃,

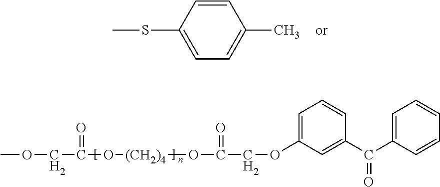

and
n is 2-10.

Specific examples are: 2,4,6-trimethylbenzophenone, 2-methylbenzophenone, 3-methylbenzophenone, 4-methylbenzophenone, 2-methoxycarbonylbenzophenone 4,4′-bis(chloromethyl)benzophenone, 4-chlorobenzophenone, 4-phenylbenzophenone, 3,3′-dimethyl-4-methoxy-benzophenone, [4-(4-methylphenylthio)phenyl]-phenylmethanone, methyl-2-benzoylbenzoate, 3-methyl-4′-phenylbenzophenone, 2,4,6-trimethyl-4′-phenylbenzophenone, 4,4′-bis(dimethylamino)benzophenone, 4,4′-bis(diethylamino)benzophenone; ESACURE TZT® available from Lamberti, (a mixture of 2,4,6-trimethylbenzophenone and 4-methylbenzophenone);

Ketal compounds, as for example benzildimethylketal (IRGACURE® 651); acetophenone, acetophenone derivatives, alpha-hydroxy ketones, alpha-alkoxyketones or alpha-aminoketones of the formula

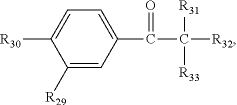

wherein
R₂₉ is hydrogen or C₁-C₁₈-alkoxy;
R₃₀ is hydrogen, C₁-C₁₈-alkyl, C₁-C₁₂hydroxyalkyl, C₁-C₁₈-alkoxy, —OCH₂CH₂—OR₄₇, morpholino, C₁-C₁₈alkyl-S—, a group H₂C═CH—, H₂C═C(CH₃)—,

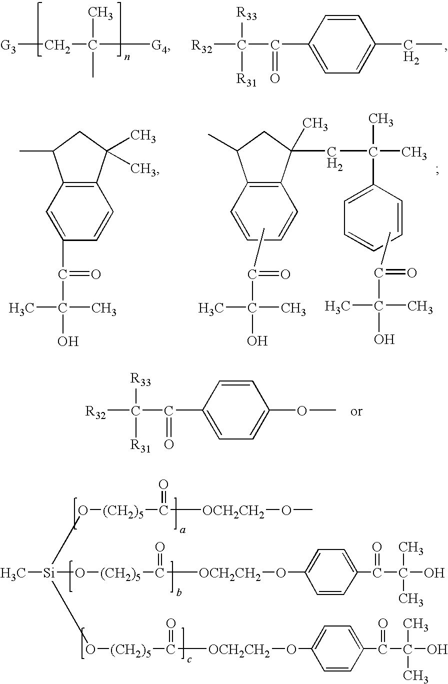

a, b and c are 1-3;
n is 2-10;
G₃ and G₄ independently of one another are end groups of the polymeric structure, preferably hydrogen or methyl;
R₄₇ is hydrogen,

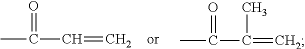

R₃₁ is hydroxy, C₁-C₁₆-alkoxy, morpholino, dimethylamino or —O(CH₂CH₂O)ₘ—C₁-C₁₆-alkyl;
R₃₂ and R₃₃ independently of one another are hydrogen, C₁-C₆-alkyl, C₁-C₁₆-alkoxy or —O(CH₂CH₂O)ₘ—C₁-C₁₆-alkyl; or unsubstituted phenyl or benzyl; or phenyl or benzyl substituted by C₁-C₁₂-alkyl; or R₃₂ and R₃₃ together with the carbon atom to which they are attached form a cyclohexyl ring;
m is 1-20, with the proviso that R₃₁, R₃₂ and R₃₃ not all together are C₁-C₁₆-alkoxy or —O(CH₂CH₂O)ₘ—C₁-C₁₆-alkyl.

For example α-hydroxycycloalkyl phenyl ketones or α-hydroxyalkyl phenyl ketones, such as for example 2-hydroxy-2-methyl-1-phenyl-propanone (DAROCUR® 1173), 1-hydroxy-cyclohexyl-phenyl-ketone (IRGACURE® 184), IRGACURE® 500 (a mixture of IRGACURE® 184 with benzophenone), 1-(4-dodecylbenzoyl)-1-hydroxy-1-methyl-ethane, 1-(4-isopropylbenzoyl)-1-hydroxy-1-methyl-ethane, 1-[4-(2-hydroxyethoxy)-phenyl]-2-hydroxy-2-methyl-1-propan-1-one (IRGACURE®2959); 2-hydroxy-1-{4-[4-(2-hydroxy-2-methyl-propionyl)-benzyl]-phenyl}-2-methyl-propan-1-one (IRGACURE®127); 2-Benzyl-1-(3,4-dimethoxy-phenyl)-2-dimethylamino-butan-1-one; 2-Hydroxy-1-{4-[4-(2-hydroxy-2-methyl-propionyl)-phenoxy]-phenyl}-2-methyl-propan-1-one,

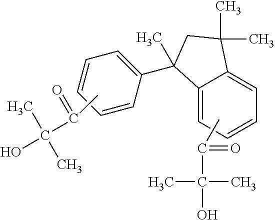

ESACURE KIP and ONE provided by Fratelli Lamberti, 2-hydroxy-1-{1-[4-(2-hydroxy-2-methyl-propionyl)-phenyl]-1,3,3-trimethyl-indan-5-yl}-2-methyl-propan-1-one, dialkoxyacetophenones, α-hydroxy- or α-aminoacetophenones, e.g. (4-methylthiobenzoyl)-1-methyl-1-morpholinoethane (IRGACURE® 907), (4-morpholinobenzoyl)-1-benzyl-1-dimethylaminopropane (IRGACURE® 369), (4-morpholinobenzoyl)-1-(4-methylbenzyl)-1-dimethylaminopropane (IRGACURE® 379), (4-(2-hydroxyethyl)aminobenzoyl)-1-benzyl-1-dimethylaminopropane), 2-benzyl-2-dimethylamino-1-(3,4-dimethoxyphenyl)butanone-1; 4-aroyl-1,3-dioxolanes, benzoin alkyl ethers and benzil ketals, e.g. dimethyl benzil ketal, phenylglyoxalic esters and derivatives thereof, e.g. oxo-phenyl-acetic acid 2-(2-hydroxy-ethoxy)-ethyl ester, dimeric phenylglyoxalic esters, e.g. oxo-phenyl-acetic acid 1-methyl-2-[2-(2-oxo-2-phenyl-acetoxy)-propoxy]ethyl ester (IRGACURE® 754); oximeesters, e.g. 1,2-octanedione 1-[4-(phenylhio)phenyl]-2-(O-benzoyloxime) (IRGACURE® OXE01), ethanone 1-[9-ethyl-6-(2-methylenzoyl)-9H-carbazol-3-yl]-1-(O-acetyloxime) (IRGACURE® OXE02), 9H-thioxanthene-2-carboxaldehyde 9-oxo-2-(O-acetyloxime), peresters, e.g. benzophenone tetracarboxylic peresters as described for example in EP 126541, monoacyl phosphine oxides, e.g. (2,4,6-trimethylbenzoyl)diphenylphosphine oxide (DAROCUR® TPO), ethyl (2,4,6 trimethylbenzoyl phenyl) phosphinic acid ester; bisacylphosphine oxides, e.g. bis(2,6-dimethoxy-benzoyl)-(2,4,4-trimethyl-pentyl)phosphine oxide, bis(2,4,6-trimethylbenzoyl)-phenylphosphine oxide (IRGACURE® 819), bis(2,4,6-trimethylbenzoyl)-2,4-dipentoxyphenylphosphine oxide, trisacylphosphine oxides, halomethyltriazines, e.g. 2-[2-(4-methoxy-phenyl)-vinyl]-4,6-bis-trihlorothyl-[1,3,5]triazine, 2-(4-methoxy-phenyl)-4,6-bis-trichloromethyl-[1,3,5]triazine, 2-(3,4-dimethoxy-phenyl)-4,6-bis-trichloromethyl-[1,3,5]triazine, 2-methyl-4,6-bis-trichloromethyl-[1,3,5]triazine, hexaarylbisimidazole/coinitiators systems, e.g. ortho-chlorohexaphenyl-bisimidazole combined with 2-mercaptobenzthiazole, ferrocenium compounds, or titanocenes, e.g. bis(cyclopentadienyl)-bis(2,6-difluoro-3-pyrryl-phenyl)titanium (IRGACURE®784). Further, borate compounds can be used as coinitiators.

Phenylglyoxalates of the formula

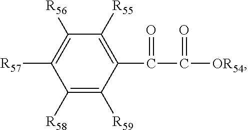

wherein
R₅₄ is hydrogen, C₁-C₁₂-alkyl or

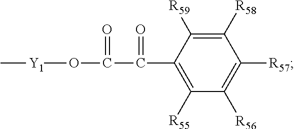

R₅₅, R₅₆, R₅₇, R₅₈ and R₅₉ independently of one another are hydrogen, unsubstituted C₁-C₁₂-alkyl or C₁-C₁₂-alkyl substituted by OH, C₁-C₄-alkoxy, phenyl, naphthyl, halogen or CN; wherein the alkyl chain optionally is interrupted by one or more oxygen atoms; or R₅₅, R₅₆, R₅₇, R₅₈ and R₅₉ independently of one another are C₁-C₄-alkoxy, C₁-C₄-alkylhio or NR₅₂R₅₃,
R₅₂ and R₅₃ independently of one another are hydrogen, unsubstituted C₁-C₁₂-alkyl or C₁-C₁₂-alkyl substituted by OH or SH wherein the alkyl chain optionally is interrupted by one to four oxygen atoms; or R₅₂ and R₅₃ independently of one another are C₂-C₁₂-alkenyl, cyclopentyl, cyclohexyl, benzyl or phenyl; and
Y₁ is C₁-C₁₂-alkylene optionally interrupted by one or more oxygen atoms.

An example is oxo-phenyl-acetic acid 2-[2-(2-oxo-2-phenyl-acetoxy)-ethoxy]-ethyl ester (IRGACURE®754). A further example of a photoinitiator is Esacure 1001 available from Lamberti: 1-[4-(4-benzoylphenylsulfanyl)phenyl]-2-methyl-2-(4-methylphenylsulfonyl)propan-1-one

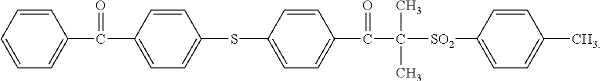

The photopolymerizable compositions generally comprise 0.05 to 20% by weight, preferably 0.01 to 10% by weight, in particular 0.01 to 8% by weight of the photoinitiator, based on the solid composition. The amount refers to the sum of all photoinitiators added, if mixtures of initiators are employed.

In addition to the photoinitiator, the photopolymerisable mixtures can comprise various additives. Examples thereof include thermal inhibitors, light stabilisers, optical brighteners, fillers and pigments, as well as white and coloured pigments, dyes, antistatics, adhesion promoters, wetting agents, flow auxiliaries, lubricants, waxes, anti-adhesive agents, dispersants, emulsifiers, anti-oxidants; fillers, e.g. talcum, gypsum, silicic acid, rutile, carbon black, zinc oxide, iron oxides; reaction accelerators, thickeners, matting agents, antifoams, and other adjuvants customary, for example, in lacquer, ink and coating technology.

To accelerate the photopolymerization it is possible to add amines as additives, for example triethanolamine, N-methyldiethanolamine, ethyl-p-dimethylaminobenzoate, 2-(dimethylamino)ethyl benzoate, 2-ethylhexyl-p-dimethylaminobenzoate, octyl-para-N,N-dimethyl-aminobenzoate, N-(2-hydroxyethyl)-N-methyl-para-toluidine or Michler's ketone. The action of the amines can be intensified by the addition of aromatic ketones of the benzophenone type. Examples of amines which can be used as oxygen scavengers are substituted N,N-dialkylanilines, as are described in EP339841. Other accelerators, coinitiators and autoxidizers are thiols, thioethers, disulfides, phosphonium salts, phosphine oxides or phosphines, as described, for example, in EP438123, in GB2180358 and in JP Kokai Hei 6-68309.

Photopolymerization can also be accelerated by adding further photosensitizers or coinitiators (as additive) which shift or broaden the spectral sensitivity. These are, in particular, aromatic compounds, for example benzophenone and derivatives thereof, thioxanthone and derivatives thereof, anthraquinone and derivatives thereof, coumarin and phenothiazine and derivatives thereof, and also 3-(aroylmethylene)thiazolines, rhodanine, camphorquinone, but also eosine, rhodamine, erythrosine, xanthene, thioxanthene, acridine, e.g. 9-phenylacridine, 1,7-bis(9-acridinyl)heptane, 1,5-bis(9-acridinyl)pentane, cyanine and merocyanine dyes.

As photosensitizers, it is also possible, for example, to consider the amines given above. Examples of suitable sensitizers are disclosed in WO06/008251, page 36, line 30 to page 38, line 8, the disclosure of which is hereby incorporated by reference.

Binders as well can be added to the novel compositions. This is particularly expedient when the photopolymerizable compounds are liquid or viscous substances. The quantity of binder may, for example, be 2-98%, preferably 5-95% and especially 20-90%, by weight relative to the overall solids content. The choice of binder is made depending on the field of application and on properties required for this field, such as the capacity for development in aqueous and organic solvent systems, adhesion to substrates and sensitivity to oxygen.

Examples of suitable binders are polymers having a molecular weight of about 2,000 to 2,000,000, preferably 5,000 to 1,000,000.

Examples of alkali developable binders are acrylic polymer having carboxylic acid function as a pendant group, such as conventionally known copolymers obtained by copolymerizing an ethylenic unsaturated carboxylic acid such as (meth)acrylic acid, 2-carboxyethyl (meth)acrylic acid, 2-carboxypropyl(meth)acrylic acid itaconic acid, crotonic acid, maleic acid, fumaric acid and ω-carboxypolycaprolactone mono(meth)acrylate, with one or more monomers selected from esters of (meth)acrylic acid, such as methyl (meth)acrylate, ethyl (meth)acrylate, propyl(meth)acrylate, butyl (meth)acrylate, benzyl (meth)acrylate, 2-ethylhexyl(meth)acrylate, hydroxyethyl(meth)acrylate, hydroxypropyl(meth)acrylate, glycerol mono(meth)acrylate, tricyclo[5.2.1.0^{2,6}]decan-8-yl(meth)acrylate, glycidyl (meth)acrylate, 2-methylglycidyl(meth)acrylate, 3,4-epoxybutyl(meth)acrylate, 6,7-epoxyheptyl(meth)acrylate, N,N-dimethylaminoethyl(meth)acrylate, N,N-diethylaminoethyl (meth)acrylate, N,N-diethylaminoethyl(meth)acrylate, N,N-dimethylaminopropyl (meth)acrylate; vinyl aromatic compounds, such as styrene, α-methylstyrene, vinyltoluene, p-chlorostyrene, vinylbenzyl glycidyl ether, 4-vinylpyridine; amide type unsaturated compounds, (meth)acrylamide diacetone acrylamide, N-methylolacrylamide, N-butoxymethacrylamide N,N-dimethylacrylamide, N,N-dimethylaminopropyl(meth)acrylamide; and polyolefin type compounds, such as butadiene, isoprene, chloroprene and the like; methacrylonitrile, methyl isopropenyl ketone, mono-2-[(meth)acryloyloxy]ethyl succinate, N-phenylmaleimide, maleic anhydride, vinyl acetate, vinyl propionate, vinyl pivalate, vinylpyrrolidone, N,N-dimethylaminoethyl vinyl ether, diallylamine, polystyrene macromonomer, or polymethyl (meth)acrylate macromonomer. Examples of copolymers are copolymers of acrylates and methacrylates with acrylic acid or methacrylic acid and with styrene or substituted styrene, phenolic resins, for example novolak, (poly)hydroxystyrene, and copolymers of hydroxystyrene with alkyl acrylates, acrylic acid and/or methacrylic acid. Preferable examples of copolymers are copolymers of methyl methacrylate/methacrylic acid, copolymers of benzyl methacrylate/methacrylic acid, copolymers of methyl methacrylate/-ethyl acrylate/methacrylic acid, copolymers of benzyl methacrylate/methacrylic acid/styrene, copolymers of benzyl methacrylate/methacrylic acid/hydroxyethyl methacrylate, copolymers of methyl methacrylate/butyl methacrylate/methacrylic acid/styrene, copolymers of methyl methacrylate/benzyl methacrylate/methacrylic acid/hydroxyphenyl methacrylate. Examples of solvent developable binder polymers are poly(alkyl methacrylates), poly(alkyl acrylates), poly(benzylmethacrylate-co-hydroxyethylmethacrylate-co-methacrylic acid), poly(benzyl-methacrylate-co-methacrylic acid); cellulose esters and cellulose ethers, such as cellulose acetate, cellulose acetobutyrate, methylcellulose, ethylcellulose; polyvinylbutyral, polyvinylformal, cyclized rubber, polyethers such as polyethylene oxide, polypropylene oxide and polytetrahydrofuran; polystyrene, polycarbonate, polyurethane, chlorinated polyolefins, polyvinyl chloride, vinyl chloride/vinylidene copolymers, copolymers of vinylidene chloride with acrylonitrile, methyl methacrylate and vinyl acetate, polyvinyl acetate, copoly-(ethylene/vinyl acetate), polymers such as polycaprolactam and poly(hexamethylene adipamide), and polyesters such as poly(ethylene glycol terephtalate) and poly(hexamethylene glycol succinate) and polyimide binder resins.

The polyimide binder resin can either be a solvent soluble polyimide or a polyimide precursor, for example, a poly(amic acid).

Interesting is a photopolymerizable composition, comprising as binder polymer, a copolymer of methacrylate and methacrylic acid. Interesting further are polymeric binder components as described e.g. in JP 10-171119-A.

“Dual curable” or “double curable” (i.e., both self-curable (in the absence of light) and photo-curable) compositions can also be used in this application.

Particularly suitable for fast curing and conversion to a solid state are compositions comprising one or several monomers and oligomers sensitive to cationic polymerization, such as epoxy resins, glycidyl ethers, vinylethers, oxetanes or other monomers and oligomers that will homopolymerized or copolymerized in a cationic curable system. Corresponding compositions comprise as polymerizable component, for example, resins and compounds that can be cationically polymerised by alkyl- or aryl-containing cations or by protons. Examples thereof include cyclic ethers, especially epoxides and oxetanes, and also vinyl ethers and hydroxy-containing compounds. Lactone compounds and cyclic thioethers as well as vinyl thioethers can also be used. Further examples include aminoplastics or phenolic resole resins. These are especially melamine, urea, epoxy, phenolic, acrylic, polyester and alkyd resins, but especially mixtures of acrylic, polyester or alkyd resins with a melamine resin. These include also modified surface-coating resins, such as, for example, acrylic-modified polyester and alkyd resins. Examples of individual types of resins that are included under the terms acrylic, polyester and alkyd resins are described, for example, in Wagner, Sarx/Lackkunstharze (Munich, 1971), pages 86 to 123 and 229 to 238, or in Ullmann/Encyclopädie der techn. Chemie, 4^{th} edition, volume 15 (1978), pages 613 to 628, or Ullmann's Encyclopedia of Industrial Chemistry, Verlag Chemie, 1991, Vol. 18, 360 ff., Vol. A19, 371 ff. The surface-coating preferably comprises an amino resin. Examples thereof include etherified and non-etherified melamine, urea, guanidine and biuret resins. Of special importance is acid catalysis for the curing of surface-coatings comprising etherified amino resins, such as, for example, methylated or butylated melamine resins (N-methoxymethyl- or N-butoxymethyl-melamine) or methylated/butylated glycolurils.

It is possible, for example, to use all customary epoxides, such as aromatic, aliphatic or cycloaliphatic epoxy resins. These are compounds having at least one, preferably at least two, epoxy group(s) in the molecule. Examples thereof are the glycidyl ethers and β-methyl glycidyl ethers of aliphatic or cycloaliphatic diols or polyols, e.g. those of ethylene glycol, propane-1,2-diol, propane-1,3-diol, butane-1,4-diol, diethylene glycol, polyethylene glycol, polypropylene glycol, glycerol, trimethylolpropane or 1,4-dimethylolcyclohexane or of 2,2-bis(4-hydroxycyclohexyl)propane and N,N-bis(2-hydroxyethyl)aniline; the glycidyl ethers of di- and poly-phenols, for example of resorcinol, of 4,4′-dihydroxyphenyl-2,2-propane, of novolaks or of 1,1,2,2-tetrakis(4-hydroxyphenyl)ethane. Examples thereof include phenyl glycidyl ether, p-tert-butyl glycidyl ether, o-icresyl glycidyl ether, polytetrahydrofuran glycidyl ether, n-butyl glycidyl ether, 2-ethylhexylglycidylether, C_{12/15}alkyl glycidyl ether and cyclohexanedimethanol diglycidyl ether. Further examples include N-glycidyl compounds, for example the glycidyl compounds of ethyleneurea, 1,3-propyleneurea or 5-dimethyl-hydantoin or of 4,4′-methylene-5,5′-tetramethyldihydantoin, or compounds such as triglycidyl isocyanurate.

Further examples of glycidyl ether components that are used in these formulations are, for example, glycidyl ethers of polyhydric phenols obtained by the reaction of polyhydric phenols with an excess of chlorohydrin, such as, for example, epichlorohydrin (e.g. glycidyl ethers of 2,2-bis(2,3-epoxypropoxyphenol)propane. Further examples of glycidyl ether epoxides that can be used in connection with the present invention are described, for example, in U.S. Pat. No. 3,018,262 and in “Handbook of Epoxy Resins” by Lee and Neville, McGraw-Hill Book Co., New York (1967).

There is also a large number of commercially available glycidyl ether epoxides that are suitable as component, such as, for example, glycidyl methacrylate, diglycidyl ethers of bisphenol A, for example those obtainable under the trade names EPON 828, EPON 825, EPON 1004 and EPON 1010 (Shell); DER-331, DER-332 and DER-334 (Dow Chemical); 1,4-butanediol diglycidyl ethers of phenolformaldehyde novolak, e.g. DEN-431, DEN-438 (Dow Chemical); and resorcinol diglycidyl ethers; alkyl glycidyl ethers, such as, for example, C₈-C₁₀glycidyl ethers, e.g. HELOXY Modifier 7, C₁₂-C₁₄glycidyl ethers, e.g. HELOXY Modifier 8, butyl glycidyl ethers, e.g. HELOXY Modifier 61, cresyl glycidyl ethers, e.g. HELOXY Modifier 62, p-tert-butylphenyl glycidyl ethers, e.g. HELOXY Modifier 65, polyfunctional glycidyl ethers, such as diglycidyl ethers of 1,4-butanediol, e.g. HELOXY Modifier 67, diglycidyl ethers of neopentyl glycol, e.g. HELOXY Modifier 68, diglycidyl ethers of cyclohexanedimethanol, e.g. HELOXY Modifier 107, trimethylolethane triglycidyl ethers, e.g. HELOXY Modifier 44, trimethylolpropane triglycidyl ethers, e.g. HELOXY Modifier 48, polyglycidyl ethers of aliphatic polyols, e.g. HELOXY Modifier 84 (all HELOXY glycidyl ethers are obtainable from Shell).

Also suitable are glycidyl ethers that comprise copolymers of acrylic esters, such as, for example, styrene-glycidyl methacrylate or methyl methacrylate-glycidyl acrylate. Examples thereof include 1:1 styrene/glycidyl methacrylate, 1:1 methyl methacrylate/glycidyl acrylate, 62.5:24:13.5 methyl methacrylate/ethyl acrylate/glycidyl methacrylate.

The polymers of the glycidyl ether compounds can, for example, also comprise other functionalities provided that these do not impair the cationic curing.

Other suitable glycidyl ether compounds that are commercially available are polyfunctional liquid and solid novolak glycidyl ether resins, e.g. PY 307, EPN 1179, EPN 1180, EPN 1182 and ECN 9699.

It will be understood that mixtures of different glycidyl ether compounds may also be used as component.

The glycidyl ethers are, for example, compounds of formula XX

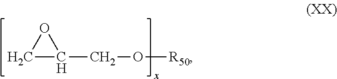

wherein
x is a number from 1 to 6; and
R₅₀ is a mono- to hexavalent alkyl or aryl radical.

Preference is given, for example, to glycidyl ether compounds of formula XX, wherein

x is the number 1, 2 or 3; and
R₅₀ when x=1, is unsubstituted or C₁-C₁₂alkyl-substituted phenyl, naphthyl, anthracyl, biphenylyl, C₁-C₂₀alkyl, or C₂-C₂₀alkyl interrupted by one or more oxygen atoms, or
R₅₀ when x=2, is 1,3-phenylene, 1,4-phenylene, C₆-C₁₀cycloalkylene, unsubstituted or halo-substituted C₁-C₄₀alkylene, C₂-C₄₀alkylene interrupted by one or more oxygen atoms, or a group

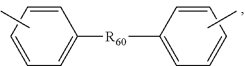

or
R₅₀ when x=3, is a radical

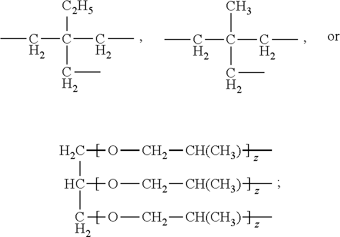

z is a number from 1 to 10; and
R₆₀ is C₁-C₂₀alkylene, oxygen or

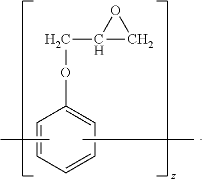

The glycidyl ethers (a1) are, for example, compounds of formula XXa

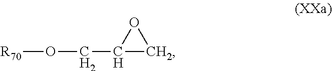

wherein
R₇₀ is unsubstituted or C₁-C₁₂alkyl-substituted phenyl; naphthyl; anthracyl; biphenylyl; C₁-C₂₀alkyl, C₂-C₂₀alkyl interrupted by one or more oxygen atoms; or a group of formula

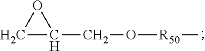

R₅₀ is phenylene, C₁-C₂₀alkylene, C₂-C₂₀alkylene interrupted by one or more oxygen atoms, or a group

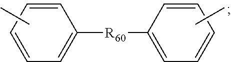

and
R₆₀ is C₁-C₂₀alkylene or oxygen.

Preference is given to the glycidyl ether compounds of formula XXb

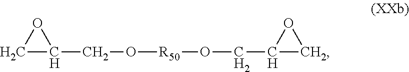

wherein
R₅₀ is phenylene, C₁-C₂₀alkylene, C₂-C₂₀alkylene interrupted by one or more oxygen atoms, or a group

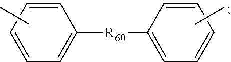

and
R₆₀ is C₁-C₂₀alkylene or oxygen.

Further examples for polymerizable component are polyglycidyl ethers and poly(β-methylglycidyl)ethers obtainable by the reaction of a compound containing at least two free alcoholic and/or phenolic hydroxy groups per molecule with the appropriate epichlorohydrin under alkaline conditions, or alternatively in the presence of an acid catalyst with subsequent alkali treatment. Mixtures of different polyols may also be used.

Such ethers can be prepared with poly(epichlorohydrin) from acyclic alcohols, such as ethylene glycol, diethylene glycol and higher poly(oxyethylene) glycols, propane-1,2-diol and poly(oxypropylene) glycols, propane-1,3-diol, butane-1,4-diol, poly(oxytetramethylene) glycols, pentane-1,5-diol, hexane-1,6-diol, hexane-2,4,6-triol, glycerol, 1,1,1-trimethylol-propane, pentaerythritol and sorbitol, from cycloaliphatic alcohols, such as resorcitol, quinitol, bis(4-hydroxycyclohexyl)methane, 2,2-bis(4-hydroxycyclohexyl)propane and 1,1-bis-(hydroxymethyl)cyclohex-3-ene, and from alcohols having aromatic nuclei, such as N,N-bis(2-hydroxyethyl)aniline and p,p′-bis(2-hydroxyethylamino)diphenylmethane. They can also be prepared from mononuclear phenols, such as resorcinol and hydroquinone, and polynuclear phenols, such as bis(4-hydroxyphenyl)methane, 4,4-dihydroxydiphenyl, bis(4-hydroxyphenyl)sulphone, 1,1,2,2-tetrakis(4-hydroxyphenyl)ethane, 2,2-bis(4-hydroxyphenyl)-propane (bis-phenol A) and 2,2-bis(3,5-dibromo-4-hydroxyphenyl)propane.

Further hydroxy compounds suitable for the preparation of polyglycidyl ethers and poly(β-methylglycidyl)ethers are the novolaks obtainable by the condensation of aldehydes, such as formaldehyde, acetaldehyde, chloral and furfural, with phenols, such as, for example, phenol, o-cresol, m-cresol, p-cresol, 3,5-dimethylphenol, 4-chlorophenol and 4-tert-butylphenol.

Poly(N-glycidyl) compounds can be obtained, for example, by dehydrochlorination of the reaction products of epichlorohydrin with amines containing at least two aminohydrogen atoms, such as aniline, n-butylamine, bis(4-aminophenyl)methane, bis(4-aminophenyl)-propane, bis(4-methylaminophenyl)methane and bis(4-aminophenyl)ether, sulphone and sulphoxide. Further suitable poly(N-glycidyl) compounds include triglycidyl isocyanurate, and N,N′-diglycidyl derivatives of cyclic alkyleneureas, such as ethyleneurea and 1,3-propyleneurea, and hydantoins, such as, for example, 5,5-dimethylhydantoin. Poly(S-glycidyl) compounds are also suitable. Examples thereof include the di-S-glycidyl derivatives of dithiols, such as ethane-1,2-dithiol and bis(4-mercaptomethylphenyl)ether.

There also come into consideration epoxy resins in which the glycidyl groups or β-methyl glycidyl groups are bonded to hetero atoms of different types, for example the N,N,O-triglycidyl derivative of 4-aminophenol, the glycidyl ether/glycidyl ester of salicylic acid or p-hydroxybenzoic acid, N-glycidyl-N′-(2-glycidyloxypropyl)-5,5-dimethyl-hydantoin and 2-glycidyloxy-1,3-bis(5,5-dimethyl-1-glycidylhydantoin-3-yl)propane.

Preference is given to diglycidyl ethers of bisphenols. Examples thereof include diglycidyl ethers of bisphenol A, e.g. ARALDIT GY 250, diglycidyl ethers of bisphenol F and diglycidyl ethers of bisphenol S. Special preference is given to diglycidyl ethers of bisphenol A.

Further glycidyl compounds of technical importance are the glycidyl esters of carboxylic acids, especially di- and poly-carboxylic acids. Examples thereof are the glycidyl esters of succinic acid, adipic acid, azelaic acid, sebacic acid, phthalic acid, terephthalic acid, tetra- and hexa-hydrophthalic acid, isophthalic acid or trimellitic acid, or of dimerised fatty acids.

Examples of polyepoxides that are not glycidyl compounds are the epoxides of vinyl-cyclohexane and dicyclopentadiene, 3-(3′,4′-epoxycyclohexyl)-8,9-epoxy-2,4-dioxaspiro-[5.5]undecane, the 3′,4′-epoxycyclohexylmethyl esters of 3,4-epoxycyclohexanecarboxylic acid, (3,4-epoxycyclohexyl-methyl 3,4-epoxycyclohexanecarboxylate), butadiene diepoxide or isoprene diepoxide, epoxidised linoleic acid derivatives or epoxidised polybutadiene.

Further suitable epoxy compounds are, for example, limonene monoxide, epoxidised soybean oil, bisphenol-A and bisphenol-F epoxy resins, such as, for example, Araldit® GY 250 (A), ARALDIT®GY 282 (F), ARALDIT® GY 285 (F)), and photocurable siloxanes that contain epoxy groups.

Further suitable cationically polymerisable or crosslinkable components can be found, for example, also in U.S. Pat. No. 3,117,099, U.S. Pat. No. 4,299,938 and U.S. Pat. No. 4,339,567.

From the group of aliphatic epoxides there are suitable especially the monofunctional symbol α-olefin epoxides having an unbranched chain consisting of 10, 12, 14 or 16 carbon atoms.

Because nowadays a large number of different epoxy compounds are commercially available, the properties of the binder can vary widely. One possible variation, for example depending upon the intended use of the composition, is the use of mixtures of different epoxy compounds and the addition of flexibilisers and reactive diluents.

The epoxy resins can be diluted with a solvent to facilitate application, for example when application is effected by spraying, but the epoxy compound is preferably used in the solvent-less state. Resins that are viscous to solid at room temperature can be applied hot.

Also suitable as crosslinkable components are all customary vinyl ethers, such as aromatic, aliphatic or cycloaliphatic vinyl ethers and also silicon-containing vinyl ethers. These are compounds having at least one, preferably at least two, vinyl ether groups in the molecule. Examples of vinyl ethers suitable for use in the compositions according to the invention include triethylene glycol divinyl ether, 1,4-cyclohexanedimethanol divinyl ether, 4-hydroxybutyl vinyl ether, the propenyl ether of propylene carbonate, dodecyl vinyl ether, tert-butyl vinyl ether, tert-amyl vinyl ether, cyclohexyl vinyl ether, 2-ethylhexyl vinyl ether, ethylene glycol monovinyl ether, butanediol monovinyl ether, hexanediol monovinyl ether, 1,4-cyclohexanedimethanol monovinyl ether, diethylene glycol monovinyl ether, ethylene glycol divinyl ether, ethylene glycol butylvinyl ether, butane-1,4-diol divinyl ether, hexanediol divinyl ether, diethylene glycol divinyl ether, triethylene glycol divinyl ether, triethylene glycol methylvinyl ether, tetra-ethylene glycol divinyl ether, pluriol-E-200 divinyl ether, polytetrahydrofuran divinyl ether-290, trimethylolpropane trivinyl ether, dipropylene glycol divinyl ether, octadecyl vinyl ether, (4-cyclohexyl-methyleneoxyethene)-glutaric acid methyl ester and (4-butoxyethene)-iso-phthalic acid ester.

Examples of hydroxy-containing compounds include polyester polyols, such as, for example, polycaprolactones or polyester adipate polyols, glycols and polyether polyols, castor oil, hydroxy-functional vinyl and acrylic resins, cellulose esters, such as cellulose acetate butyrate, and phenoxy resins.

Further cationically curable formulations can be found, for example, in EP119425.

As crosslinkable component, preference is given to cycloaliphatic epoxides, or epoxides based on bisphenol A.

Accordingly, the composition contains at least one compound selected from the group of cycloaliphatic epoxy compounds, glycidyl ethers, oxetane compounds, vinyl ethers, acid-crosslinkable melamine resins, acid-crosslinkable hydroxymethylene compounds and acid-crosslinkable alkoxy-methylene compounds.

If desired, the composition can also contain free-radically polymerisable components, such as ethylenically unsaturated monomers, oligomers or polymers.

It is also possible to use compounds that can be crosslinked equally both free-radically and cationically. Such compounds contain, for example, both a vinyl group and a cycloaliphatic epoxy group. Examples thereof are described in JP 2-289611-A and U.S. Pat. No. 6,048,953.

Mixtures of two or more such free-radically polymerisable materials can also be used.

Binders may also be added to the compositions, this being especially advantageous when the photopolymerisable compounds are liquid or viscous substances. The amount of binder may be, for example, from 5 to 95% by weight, preferably from 10 to 90% by weight and especially from 40 to 90% by weight, based on total solids. The unsaturated compounds may also be used in admixture with non-photopolymerisable film-forming components.

The alkyd resins used as crosslinkable component contain a large number of unsaturated, aliphatic compounds, at least some of which are polyunsaturated. The unsaturated aliphatic compounds preferably used for the preparation of those alkyd resins are unsaturated aliphatic monocarboxylic acids, especially polyunsaturated aliphatic monocarboxylic acids.

Examples of mono-unsaturated fatty acids are myristoleic acid, palmitic acid, oleic acid, gadoleic acid, erucic acid and ricinoleic acid. Preferably fatty acids containing conjugated double bonds, such as dehydrogenated castor oil fatty acid and/or tung oil fatty acid, are used. Other suitable monocarboxylic acids include tetrahydrobenzoic acid and hydrogenated or non-hydrogenated abietic acid or the isomers thereof. If desired, the monocarboxylic acid in question may be used wholly or in part in the form of a triglyceride, e.g. as vegetable oil, in the preparation of the alkyd resin. If desired, mixtures of two or more such mono-carboxylic acids or triglycerides may be used, optionally in the presence of one or more saturated, (cyclo)aliphatic or aromatic monocarboxylic acids, e.g. pivalic acid, 2-ethyl-hexanoic acid, lauric acid, palmitic acid, stearic acid, 4-tert-butyl-benzoic acid, cyclo-pentanecarboxylic acid, naphthenic acid, cyclohexanecarboxylic acid, 2,4-dimethylbenzoic acid, 2-methylbenzoic acid and benzoic acid.

If desired, polycarboxylic acids may also be incorporated into the alkyd resin, such as phthalic acid, isophthalic acid, terephthalic acid, 5-tert-butylisophthalic acid, trimellitic acid, pyromellitic acid, succinic acid, adipic acid, 2,2,4-trimethyladipic acid, azelaic acid, sebacic acid, dimerised fatty acids, cyclopentane-1,2-dicarboxylic acid, cyclohexane-1,2-dicarboxylic acid, 4-methylcyclohexane-1,2-dicarboxylic acid, tetrahydrophthalic acid, endomethylene-cyclohexane-1,2-dicarboxylic acid, butane-1,2,3,4-tetracarboxylic acid, endoisopropylidene-cyclohexane-1,2-dicarboxylic acid, cyclohexane-1,2,4,5-tetracarboxylic acid and butane-1,2,3,4-tetracarboxylic acid. If desired, the carboxylic acid in question may be used as an anhydride or in the form of an ester, for example an ester of an alcohol having from 1 to 4 carbon atoms.

In addition, the alkyd resin can be composed of di- or poly-valent hydroxyl compounds.

Examples of suitable divalent hydroxyl compounds are ethylene glycol, 1,3-propanediol, 1,6-hexanediol, 1,12-dodecanediol, 3-methyl-1,5-pentanediol, 2,2,4-trimethyl-1,6-hexane-diol, 2,2-dimethyl-1,3-propanediol and 2-methyl-2-cyclohexyl-1,3-propanediol. Examples of suitable triols are glycerol, trimethylolethane and trimethylolpropane. Suitable polyols having more than 3 hydroxyl groups are pentaerythritol, sorbitol and etherified products of the compounds in question, such as ditrimethylolpropane and di-, tri- and tetra-pentaerythritol. Preferably, compounds having from 3 to 12 carbon atoms, e.g. glycerol, pentaerythritol and/or dipentaerythritol, are used.

The alkyd resins can be obtained by direct esterification of the constituents, with the option that some of those components may already have been converted into ester diols or polyester diols. The unsaturated fatty acids can also be used in the form of a drying oil, such as linseed oil, tuna fish oil, dehydrogenated castor oil, coconut oil and dehydrogenated coconut oil. The final alkyd resin is then obtained by transesterification with the other acids and diols added. The transesterification is advantageously carried out at a temperature in the range of from 115 to 250° C., optionally in the presence of solvents such as toluene and/or xylene. The reaction is advantageously carried out in the presence of a catalytic amount of a transesterification catalyst. Examples of suitable transesterification catalysts include acids, such as p-toluenesulphonic acid, basic compounds, such as an amine, or compounds such as calcium oxide, zinc oxide, tetraisopropyl orthotitanate, dibutyltin oxide and tri-phenylbenzylphosphonium chloride.

The vinyl ether, acetal and/or alkoxysilane compounds used as part of crosslinkable component preferably contain at least two vinyl ether, acetal and/or alkoxysilane groups and have a molecular weight of 150 or more. Those vinyl ether, acetal and/or alkoxysilane compounds can be obtained, for example, by the reaction of a commercially available vinyl ether, acetal and/or alkoxysilane compound containing a vinyl ether, acetal and/or alkoxysilane group and in addition a maximum of one functional amino, epoxy, thiol, isocyanate, acrylic, hydride or hydroxyl group, with a compound having at least two groups capable of reacting with an amino, epoxy, thiol, isocyanate, acrylic, hydride or hydroxyl group. As examples thereof there may be mentioned compounds having at least two epoxy, isocyanate, hydroxyl and/or ester groups or compounds having at least two ethylenically or ethynylenically unsaturated groups.

As polymerizable component, preference is given to a composition in which the vinyl ether, acetal and/or alkoxysilane compounds are covalently bonded to the alkyd resin by addition via a reactive group such as an amino, hydroxyl, thiol, hydride, epoxy and/or isocyanate group. For that purpose, the compounds must have at least one group capable of forming an adduct with the reactive groups present in the alkyd resin.

To incorporate vinyl ether groups into the alkyd resin, use is made of a vinyloxyalkyl compound, the alkyl group of which is substituted by a reactive group, such as a hydroxyl, amino, epoxy or isocyanate group, that is capable of forming an adduct with one or more of the reactive groups present in the alkyd resin.

As polymerizable component, preference is given to compositions in which the ratio of the number of oxidatively drying groups present in the alkyd resin to the number of groups that are reactive in the presence of an acid is in the range of from 1/10 to 15/1, especially from 1/3 to 5/1. Instead of a single modified alkyd resin, it is also possible to use a plurality of alkyd resins, with one alkyd resin being highly modified and the others being less modified or not modified at all.

Examples of vinyl ether compounds capable of being covalently bonded to the alkyd resin are ethylene glycol monovinyl ether, butanediol monovinyl ether, hexanediol monovinyl ether, triethylene glycol monovinyl ether, cyclohexanedimethanol monovinyl ether, 2-ethylhexanediol monovinyl ether, polytetrahydrofuran monovinyl ether, tetraethylene glycol monovinyl ether, trimethylolpropane divinyl ether and aminopropyl vinyl ether.

Adducts can be formed, for example, by reacting the vinyl ether compounds containing a hydroxyl group or amino group with an excess of a diisocyanate, followed by the reaction of that free-isocyanate-group-containing adduct with the free hydroxyl groups of the alkyd resin. Preferably, a process is used in which first the free hydroxyl groups of the alkyd resin react with an excess of a polyisocyanate, and then the free isocyanate groups react with an amino-group- or hydroxyl-group-containing vinyl ether compound. Instead of a diisocyanate, it is also possible to use a diester. Transesterification of the hydroxyl groups present in the alkyd resin with an excess of the diester, followed by transesterification or transamidation of the remaining ester groups with hydroxy-functional vinyl ether compounds or amino-functional vinyl ether compounds, respectively, yields vinyl-ether-functional alkyd resins. It is also possible to incorporate (meth)acrylate groups into the alkyd resin during preparation of the alkyd resin, by carrying out the preparation in the presence of a hydroxy-functional (meth)acrylate ester, such as hydroxyethyl methacrylate (HEMA), and then reacting the thus functionalised alkyd resin by means of a Michael reaction with a vinyl-ether-group-containing compound and a primary-amino-group-containing compound, followed by reaction with e.g. an isocyanate compound, in order to obtain a non-basic nitrogen atom.

An example of such a reaction is described, for example, in WO99/47617. Esterification of ricinine fatty acid with dipentaerythritol, followed by transesterification of the free hydroxyl groups with diethyl malonate and 4-hydroxybutyl vinyl ether in a suitable ratio, yields a vinyl-ether-functional alkyd resin suitable for use as polymerizable component.

When free-radically polymerisable components are added to the formulation according to the invention, it may be advantageous to add also a suitable free-radical photoinitiator or a mixture of such photoinitiators

A compound that increases the solubility of the cationically or acid-catalytically polymerisable or crosslinkable compound in a developer under the action of acid;

The photopolymerisable mixtures can comprise various additives in addition to the photoinitiator. Examples thereof include thermal inhibitors, light stabilisers, optical brighteners, fillers and pigments, as well as white and coloured pigments, dyes, antistatics, adhesion promoters, wetting agents, flow auxiliaries, lubricants, waxes, anti-adhesive agents, dispersants, emulsifiers, anti-oxidants; fillers, e.g. talcum, gypsum, silicic acid, rutile, carbon black, zinc oxide, iron oxides; reaction accelerators, thickeners, matting agents, antifoams, and other adjuvants customary, for example, in lacquer, ink and coating technology.

Acceleration of the photopolymerisation can also be effected by adding as further additives photosensitisers that shift or broaden the spectral sensitivity. These are especially aromatic carbonyl compounds, such as, for example, benzophenone, thioxanthone, and especially also isopropylthioxanthone, phenothiazine derivatives, anthraquinone and 3-acyl-coumarin derivatives, terphenyls, styryl ketones, and 3-(aroylmethylene)-thiazolines, camphorquinone, and also eosin, rhodamine and erythrosin dyes, and anthracene derivatives, such as, for example, 9-methylanthracene, 9,10-dimethylanthracene, 9,10-diethoxyanthracene, 9,10-dibutyloxyanthracene, 9-methoxyanthracene, 9-anthracenemethanol, especially 9,10-dimethoxy-2-ethyl-anthracene, 9,10-dibutyloxyanthracene and 9,10-diethoxyanthracene. Further suitable photosensitisers are mentioned, for example, in WO 98/47046.

Further examples of suitable photosensitisers are disclosed in WO 06/008251, page 36, line 30 to page 38, line 8, the disclosure of which is hereby incorporated by reference.

The sensitisers described above are customary in the art and are accordingly used in amounts customary in the art, preferably in a concentration of from 0.05 to 5%, especially in a concentration of from 0.1 to 2%, based on the composition.

The compositions according to the invention may additionally comprise further photoinitiators (e), such as, for example, cationic photoinitiators, photo acid-formers and free-radical photoinitiators as co-initiators in amounts of from 0.01 to 15%, preferably from 0.1 to 5%.

It is also possible to use electron donor compounds, such as, for example, alkyl- and aryl-amine donor compounds, in the composition. Such compounds are, for example, 4-di-methylaminobenzoic acid, ethyl 4-dimethylaminobenzoate, 3-dimethylaminobenzoic acid, 4-dimethylaminobenzoin, 4-dimethylaminobenzaldehyde, 4-dimethylaminobenzonitrile and 1,2,4-tri-methoxybenzene. Such donor compounds are preferably used in a concentration of from 0.01 to 5%, especially in a concentration of from 0.05 to 0.50%, based on the formulation.

Examples of cationic photoinitiators and acid-formers are phosphonium salts, diazonium salts, pyridinium salts, iodonium salts, such as for example tolylcumyliodonium tetrakis(pentafluorophenyl)borate, 4-[(2-hydroxy-tetradecyloxy)phenyl]phenyliodonium hexafluoroantimonate or hexafluorophosphate (SarCat® CD 1012; Sartomer), tolylcumyliodonium hexafluorophosphate, 4-isobutylphenyl-4′-methylphenyliodonium hexafluorophosphate (IRGACURE° 250, Ciba Specialty Chemicals), 4-octyloxyphenyl-phenyliodonium hexafluorophosphate or hexafluoroantimonate, bis(dodecylphenyl)iodonium hexafluoroantimonate or hexafluorophosphate, bis(4-methylphenyl)iodonium hexafluorophosphate, bis(4-methoxy-phenyl)iodonium hexafluorophosphate, 4-methylphenyl-4′-ethoxyphenyliodonium hexafluorophosphate, 4-methylphenyl-4′-dodecylphenyliodonium hexafluorophosphate, 4-methylphenyl-4′-phenoxyphenyliodonium hexafluorophosphate. Of all the iodonium salts mentioned, compounds with other anions are, of course, also suitable; further sulphonium salts, obtainable, for example, under the trade names CYRACURE® UVI-6990, CYRACURE® UVI-6974 (Union Carbide), DEGACURE® KI 85 (Degussa), SP-55, SP-150, SP-170 (Asahi Denka), GE UVE 1014 (General Electric), SarCat® KI-85 (=triarylsulphonium hexafluorophosphate; Sartomer), SarCat® CD 1010 (=mixed triarylsulphonium hexafluoroantimonate; Sartomer); SarCat® CD 1011(=mixed triarylsulphonium hexafluorophosphate; Sartomer); ferrocenium salts, e.g. (⁶-isopropylbenzene)(⁵-cyclopentadienyl)-iron-II hexafluorophosphate, nitrobenzylsulphonates, alkyl- and aryl-N-sulphonyloxyimides and further known alkylsulphonic acid esters, haloalkylsulphonic acid esters, 1,2-disulphones, oxime sulphonates, benzoin tosylate, tolylsulphonyloxy-2-hydroxy-2-methyl-1-phenyl-1-propanone and further known beta-ketosulphones, beta-sulphonylsulphones, bis(alkylsulphonyl)diazomethane, bis(4-tert-butyl-phenyl-sulphonyl)-diazomethane, benzoyl-tosyl-diazomethane, iminosulphonates and imidosulphonates and trichloromethyl-s-triazines and other haloalkyl-group-containing compounds. Examples of further suitable additional photolatent acids (b1) include the examples of cationic photoinitiators and acid-formers as given in WO04/074242, page 38, line 10 to page 41, line 14, as well as the compounds disclosed in the examples of WO04/074242, the relevant disclosure of which is incorporated herein by reference.

Exposure to radiation can be followed by a thermal post-curing step.

Also suitable for fast curing and conversion to a solid state are compositions comprising one or several monomers and oligomers sensitive to polycondensation catalysed by photolatent bases. Photolatent bases are in particular photolatent tertiary amines or amidines. Also suitable for fast curing and conversion to a solid state are compositions consisting in combinations of the previously described chemistries, often named as hybrid curing system.

A large number of the most varied kinds of light source may be used. Both point sources and planiform radiators (lamp arrays) are suitable. Examples are carbon arc lamps, xenon arc lamps, medium-pressure, super-high-pressure, high-pressure and low-pressure mercury radiators doped, where appropriate, with metal halides (metal halide lamps), microwave-excited metal vapour lamps, excimer lamps, superactinic fluorescent tubes, fluorescent lamps, argon incandescent lamps, flash lamps, photographic floodlight lamps, light-emitting diodes (LED), electron beams and X-rays. Advantageously the dose of radiation used in process step c) is e.g. from 1 to 1000 mJ/cm². When the lamp is a medium pressure mercury lamp, it may have a power in the range of 40-450 Watts. In a preferred embodiment of the present invention, the U.V. lamp is disposed on (plate) or in (cylinder) the means for forming an optically variable image.

The U.V. light source may comprise a lamp. The lamp may have a power in the range of 200-450 Watts.

The silicon and/or fluorine containing compound comprises organopolyiloxanes, i.e. compounds which contain the unit(s)

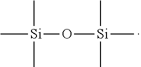

It is to be understood that the organopolysiloxane to be cured for example is a monomer, an oligomer or polymer, e.g. a homopolymer, a copolymer or terpolymer and is either a single compound or a mixture of two or more different siloxanes.

The siloxanes are linear or branched, linear siloxanes are preferred. Further, compounds not comprising fluorine are preferred.

The organopolysiloxane can contain one or more groups (e.g. vinyl, acryl, methacryl etc.) which are reactive towards radical polymerization. E.g. TEGO RC 711, TEGO RC 902 etc. The organopolysiloxane can contain one or more groups (e.g. vinyl, epoxy, glycidyl etc.) which are reactive towards cationic polymerization.

In particular interesting are silicon and/or fluorine containing compounds of the formula I,

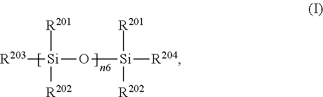

wherein
n6 is 1 to 1000;
R²⁰¹, R²⁰², R²⁰³ and R²⁰⁴ independently of one another are C₁-C₂₀alkyl; C₁-C₂₀alkyl substituted by one or more group(s) selected from X¹⁰, OH, CₚF₂ₚ₊₁, phenyl and Y¹⁰;
C₂-C₅₀alkyl interrupted by one or more O; C₂-C₅₀alkyl interrupted by one or more O and substituted by one or more group(s) selected from X¹⁰, CₚF₂ₚ₊₁, OH, phenyl and Y¹⁰;
C₂-C₂₀alkenyl; C₂-C₂₀alkenyl substituted by one or more group(s) selected from X¹⁰, CₚF₂ₚ₊₁, OH, C₁-C₁₀alkoxy, phenyl and Y¹⁰;
C₃-C₂₀alkenyl interrupted by one or more O; C₃-C₂₀alkenyl interrupted by one or more O and substituted by one or more group(s) selected from X¹⁰, CₚF₂ₚ₊₁, OH, C₁-C₁₀alkoxy, phenyl and Y¹⁰;
phenyl; phenyl substituted by one or more group(s) selected from X¹⁰, CₚF₂ₚ₊₁, C₁-C₁₀alkyl, C₂-C₁₀alkenyl, OH, C₁-C₁₀alkoxy and Y¹⁰;
naphthyl; naphthyl substituted by one or more group(s) selected from X¹⁰, CₚF₂ₚ₊₁, C₁-C₁₀alkyl, C₂-C₁₀alkenyl, OH, C₁-C₁₀alkoxy, phenyl and Y¹⁰;
biphenylyl; biphenylyl substituted by one or more group(s) selected from X¹⁰, CₚF₂ₚ₊₁, C₁-C₁₀alkyl, C₂-C₁₀alkenyl, OH, C₁-C₁₀alkoxy and Y¹⁰;
C₁-C₂₀alkoxy; C₁-C₂₀alkoxy substituted by one or more group(s) selected from X¹⁰, CₚF₂ₚ₊₁, C₂-C₁₀alkenyl, OH, phenyl and Y¹⁰;
C₂-C₅₀alkoxy interrupted by one or more O; C₂-C₅₀alkoxy interrupted by one or more O and substituted by one or more group(s) selected from X¹⁰, CₚF₂ₚ₊₁, C₂-C₁₀alkenyl, OH, phenyl and Y¹⁰;
phenoxy; phenyloxy substituted by one or more group(s) selected from X¹⁰, CₚF₂ₚ₊₁, C₁-C₁₀alkyl, C₂-C₁₀alkenyl, OH, C₁-C₁₀alkoxy and Y¹⁰; naphthyloxy; naphthyloxy substituted by one or more group(s) selected from X¹⁰, CₚF₂ₚ₊₁, C₁-C₁₀alkyl, C₂-C₁₀alkenyl, OH, C₁-C₁₀alkoxy and Y¹⁰;
biphenyloxy; biphenyloxy substituted by one or more group(s) selected from X¹⁰, CₚF₂ₚ₊₁, C₁-C₁₀alkyl, C₂-C₁₀alkenyl, OH, C₁-C₁₀alkoxy and Y¹⁰;
or R²⁰¹, R²⁰², R²⁰³ and R²⁰⁴ independently of one another are Y10;
or the radicals R²⁰³ and R²⁰⁴ of different compounds of the formula (I) together form a C₃-C₅₀alkylene chain, which optionally is interrupted by one or more O and/or

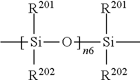

and which optionally is substituted by one or more R²¹⁰;

### Y10 is

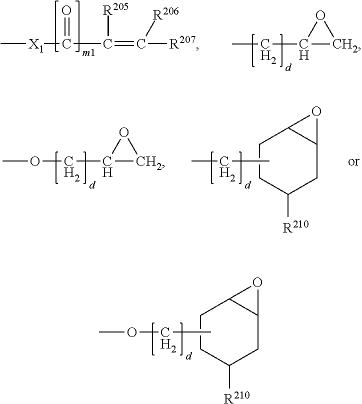

p is 1 to 24;
m1 is 0 or 1;
d is an integer from 0-10;
X¹⁰ is hydrogen, halogen, OR²⁰⁸, NR²⁰⁸R²⁰⁹; SR²⁰⁸; CN, NCO, COOR²⁰⁸, OCOR²⁰⁸, CONR²⁰⁸R²⁰⁹, NR²⁰⁸COR²⁰⁹, OCOOR²⁰⁸, OCONR²⁰⁸R²⁰⁹, NR²⁰⁸COOR²⁰⁹ or Y¹⁰;
X₁ is O, NR²⁰⁸ or C₁-C₁₂alkylene;
R²⁰⁵, R²⁰⁶ and R²⁰⁷ independently of one another are hydrogen or C₁-C₆alkyl;
R²⁰⁸ and R²⁰⁹ independently of one another are hydrogen or R²¹¹,
R²¹⁰ is hydrogen or C₁-C₁₀alkyl;
R²¹¹ is C₁-C₂₀alkyl, phenyl-C₁-C₄alkyl, phenyl, naphthyl or biphenylyl; all of which optionally are substituted by one or more R²¹²;
R²¹² is hydrogen, halogen, OR²¹³, NR²¹³R²¹⁴, SR²¹³, CN, NCO, COOR²¹³, OCOR²¹⁴, CONR²¹³R²¹⁴, NR²¹³COR²¹⁴, OCOOR²¹³, OCONR²¹³R²¹⁴, NR²¹³COOR²¹⁴ or Y¹⁰;
R²¹³ and R²¹⁴ independently of one another are hydrogen, C₁-C₂₀alkyl, phenyl-C₁-C₄alkyl, phenyl, naphthyl or biphenylyl;
provided that
(d1) at least one of R²⁰¹, R²⁰², R²⁰³ or R²⁰⁴ comprises a group

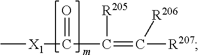

or
(d2) at least one of R²⁰¹, R²⁰², R²⁰³ or R²⁰⁴ comprises a group

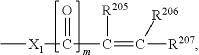

wherein m is 0 and X₁ is O, or comprises a group

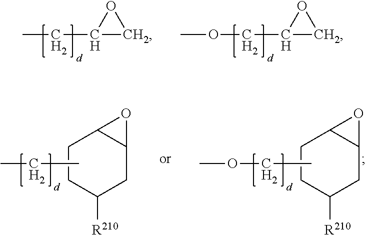

or
(d3) at least one of R²⁰¹, R²⁰², R²⁰³ or R²⁰⁴ comprises an olefinic group and at least one of R²⁰¹, R²⁰², R²⁰³ or R²⁰⁴ is hydrogen, wherein the Si—H group and the olefinic group are located in one or different organopolysiloxane chains of the molecule or in different molecules; or
(d4) at least two of R²⁰¹, R²⁰², R²⁰³ or R²⁰⁴ are selected from C₁-C₁₀alkoxy, OH, CₚF₂ₚ₊₁ and halogen, or
at least one of R²⁰¹, R²⁰², R²⁰³ or R²⁰⁴ is selected from C₁-C₁₀alkoxy and OH and at least one of R²⁰¹, R²⁰², R²⁰³ or R²⁰⁴ is CₚF₂ₚ₊₁ or halogen; or
(d5) the silicon and/or fluorine containing layer comprises any mixtures of compounds according to (d1), (d2), (d3) or (d4).

In the compounds of the formula I, all R²⁰¹ in one molecule are not imperatively identical, but optionally have different meanings in the frame of the given definitions. That means not all R²⁰¹ in the polymeric chain have to be identical, but optionally have different meanings. The same applies for R²⁰².

The polyorganosilicon backbone in the compounds of the formula I is linear or branched.

If the radicals R²⁰³ and R²⁰⁴ of different compounds of the formula (I) together form a C₃-C₅₀alkylene chain, which optionally is interrupted by one or more O and/or

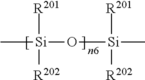

and which optionally is substituted by one or more R²¹⁰; for example structures according to the following formula (Ia) are obtained:

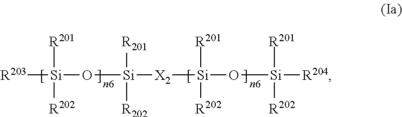

wherein R²⁰¹, R²⁰², R²⁰³, R²⁰⁴ and n are as defined above and wherein n optionally denotes different integers for each polysiloxane chain of formula (Ia);
X₂ is C₃-C₅₀alkylene, optionally interrupted by one or more O and/or

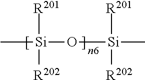

and
optionally substituted by one or more R²¹⁰; and
R²¹⁰ is as defined above.
n6 is 1 to 1000; for example n6 is 5 to 1000, preferably n6 is 10 to 500.
m is 0 or 1, preferably 1.
d is an integer from 0 to 10, preferably is 0, 1 or 2.

In the compounds of the formula I, wherein (d1) at least one of R²⁰¹, R²⁰², R²⁰³ or R²⁰⁴ comprises a group

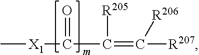

curing of the silicon component is performed via the olefinic groups.

The siloxane comprises an olefinic functional group, for example an acrylate, a methacrylate or a vinylether functional group, preferably an acrylate or methacrylate. The siloxane, is for example further substituted and the olefinic functional group is part of substituent R²⁰¹ to R²⁰⁴. That is, the olefinic functional group also may be attached directly to a Si-atom.

The organopolysiloxane contains one or more groups which are reactive toward free radical polymerization, e.g. initiated by radiation. Examples of such groups include vinyl groups including vinyl acrylate groups, vinyl ether groups, vinyl ester groups, and epoxy acrylate groups. The organopolysiloxanes containing the radiation reactive groups are usually present in the compositions in amounts of from about 0.01% to 20%, 0.01% to about 10% by weight, for example from about 1% to about 5% by weight. The acrylic functional organopolysiloxanes for example contain about 0.1% to 75%, 0.1% to 50%, 0.1% to 20%, by weight of acryloxy or methacryloxy groups, more often, from about 1% to 15%, 3% to about 15% by weight of the acryloxy or methacryloxy groups. Interesting are further such polysiloxanes which have an average molecular weight of from about 1000 to about 20000. Siloxanes of higher molecular weight are also suitable. The organopolysiloxanes are linear or branched. Preferred are linear compounds.

Examples of silicon and/or fluorine containing compounds which can advantageously be used in the composition of the present invention are BYK 307, 377, 345 and 340.

Polymerization degree has to be at least of 95% to allow a good release, preferentially higher than 97%. The polymerization degree can be measured by ATR-IR spectroscopy, by following the disappearance of the acrylate band at 1410 cm⁻¹. In the case of UV-shims, getting high polymerization degree can be obtained by increasing the light dose (higher light intensity or longer exposure time), by increasing the amount of photoinitiator or replacing the photoinitiator by a more reactive one, or by increasing the polymerization temperature.

Also the concentration of UV-reactive functions in the UV-curable formulation is important, as a low concentration will provide a soft material, which will exhibit a low chemical and mechanical resistance. If the concentration of reactive groups is too high, it is not possible to get complete curing. As an example, the mol concentration of reactive functions by kg of formulation can be comprised between 0.5 and 10, preferentially between 2 and 7. A typical mol concentration around 5 is well adapted for this purpose.

A typical acrylate formulation comprises acrylate monomers, oligomers and polymers, a photoinitiator(s), and optionally a silicon and/or fluorine containing compound.

The terms “acrylic” and “acrylate” are used generally to include derivatives of acrylic acids as well as substituted acrylic acids such as methacrylic acid, ethacrylic acid, etc., unless clearly indicated otherwise.

Specific examples of suitable polyfunctional acrylate monomers are diethylene glycol diacrylate, triethylene glycol diacrylate, tetraethylene glycol diacrylate, polyethylene glycol diacrylate, dipropylene glycol diacrylate, tripropylene glycol diacrylate, tetrapropylene glycol diacrylate, polypropylene glycol diacrylate, glyceryl ethoxylate diacrylate, glyceryl propoxylate diacrylate, glyceryl ethoxylate triacrylate, glyceryl propoxylate triacrylate, trimethylolpropane triacrylate, trimethylolpropane ethoxylate triacrylate, trimethylolpropane propoxylate triacrylate, neopentylglycol ethoxylate diacrylate, neopentylglycol propoxylate diacrylate, monomethoxy trimethylolpropane ethoxylate diacrylate, pentaerythritol ethoxylate tetraacrylate, pentaerythritol propoxylate tetraacrylate, dipentaerythritol ethoxylate pentaacrylate, dipentaerythritol propoxylate pentaacrylate, di-trimethylolpropane ethoxylate tetraacrylate, Bisphenol A ethoxylate diacrylate, Bisphenol A propoxylate diacrylate, Bisphenol A epoxyacrylate etc. Examples of polyfunctional acrylate monomers include 1,8-octanediol diacrylate, 1,10-decanediol diacrylate, polybutadiene diacrylate, etc. A silicone compound, such as silicone hexaacrylate, or an additive, such as Dow Corning 57 may optionally be added. An example of an amine modified acrylate is Ebecryl 7100.

The acrylate monomers and binders are, for example, present in an amount of 0 to 99%, 1% to 99%, 10% to 99%, 50% to 99%, 60% to about 99% by weight, e.g. 70% or 75% by weight. The molecular weight of the acrylate monomers ranges from about 300 to 15000, e.g. 300 to 5000 or 300 to 3000.

In a preferred embodiment of the present invention the acrylate formulation comprises Bisphenol A epoxyacrylate diluted with 25% of tripropyleneglycol diacrylate (TPGDA), a propoxylated/ethoxylated pentaerythritol tetraacrylate, propoxylated glycerol triacrylate, tripropyleneglycol diacrylate, silicone hexaacrylate, photoinitiators, such as 4-phenylbenzophenone and Esacure KIP 150, and a silicone additive, such as Dow Corning 57. Typically photoinitiators are present in an amount of 0.5-10%. An amine modified acrylate and trimethylolpropane triacrylate may optionally be present.

The present invention is also directed to optically variable image forming means, comprising the duplicated shim according to the present invention.

The means for forming an optically variable image, such a diffraction grating may comprise a shim or a seamless roller. The shim or roller may be manufactured from any suitable transparent material, such as, for example, polyester. Polyester shims may be made by coating polyester with the UV curable composition of the present invention and contact copying the master image and curing the transferred image by means of ultraviolet light. In a preferred embodiment an acrylic sheet is coated with the UV curable composition; a nickel shim holding the images is then applied under pressure to the wet acrylic sheet and then the composition is cured through the clear acrylic sheet. Required is a UV curable composition that will adhere to the acrylic and not the nickel shim when cured.

Seamless cylinders may be made by coating polyester with the UV curable composition and contact copying the master image and curing the transferred image by means of ultraviolet light.

Accordingly, the duplicated shim is a cylinder comprising the cured UV-curable composition carrying the optically variable image; or the duplicated shim is a cylinder comprising a sheet of a (plastic) material comprising the cured UV-curable composition carrying the optically variable image; or the duplicated shim is a belt system comprising a quartz tube having an UV lamp mounted inside, a chilled drive roller and a belt of a (plastic) material comprising the cured UV-curable composition carrying the optically variable image.

The invention relates also to a method for producing a seam free transfer cylinder for the production and use of optically variable devices and patterns in printing. More particularly the invention is directed to a method of manufacturing a cylinder with optically variable diffraction and other sub-microscopic gratings constructed to obscure perceivable joint lines and seams associated with conventional embossing systems using nickel shims as the vehicle to impart the grating to a substrate.

In another embodiment a cylinder is coated with ultraviolet curable resin, placing a clear transfer film with a sub-microscopic or holographic diffraction pattern or image to the surface of the ultraviolet resin via a nip and cured with ultraviolet light. The cylinder can then be used to directly transfer the sub-microscopic or holographic diffraction pattern or image into the surface of a printed ultraviolet cured lacquer on the first surface of a substrate. Alternatively, the substrate may be subsequently printed with metallic ink off-line on conventional printing equipment.

The upper surface of the substrate may be printed with a metallic ink in discrete registered i.e. registered with other print already on the document etc., or in a position on the document etc., so that other subsequent printing can take place and/or non-registered areas as images/patterns, or in a stripe in discrete registered and/or non-registered or all over the substrate surface. The substrate may then pass through a nip roller to a cylinder carrying sub-microscopic, holographic or other diffraction grating pattern or image in the form of a polyester shim affixed to the surface of a cylinder. In a preferred embodiment the images or patterns are held on a seamless cylinder with the sub-microscopic pattern or image on it, so that the accuracy of the transfer can be improved a cylinder. The sub-microscopic optically variable image or holographic grating may then be transferred from the shim or seamless roller into the surface of the exposed ultraviolet lacquer by means of bringing the surface of the shim or seamless roller into contact with the surface of the exposed ultraviolet lacquer. An ultraviolet light source may be exposed through the surface of the transparent OVI forming means and instantly cures the lacquer by exposure to ultraviolet light. The ultraviolet light sources may be lamps in the range of 40 to 500 W/cm² disposed inside the cylinder, curing through the printed ultraviolet lacquer and fixing the transferred sub-microscopic or holographic diffraction grating.

Specific embodiments of the present invention will now be described, by way of example only, with reference to the accompanying examples and figures, in which:

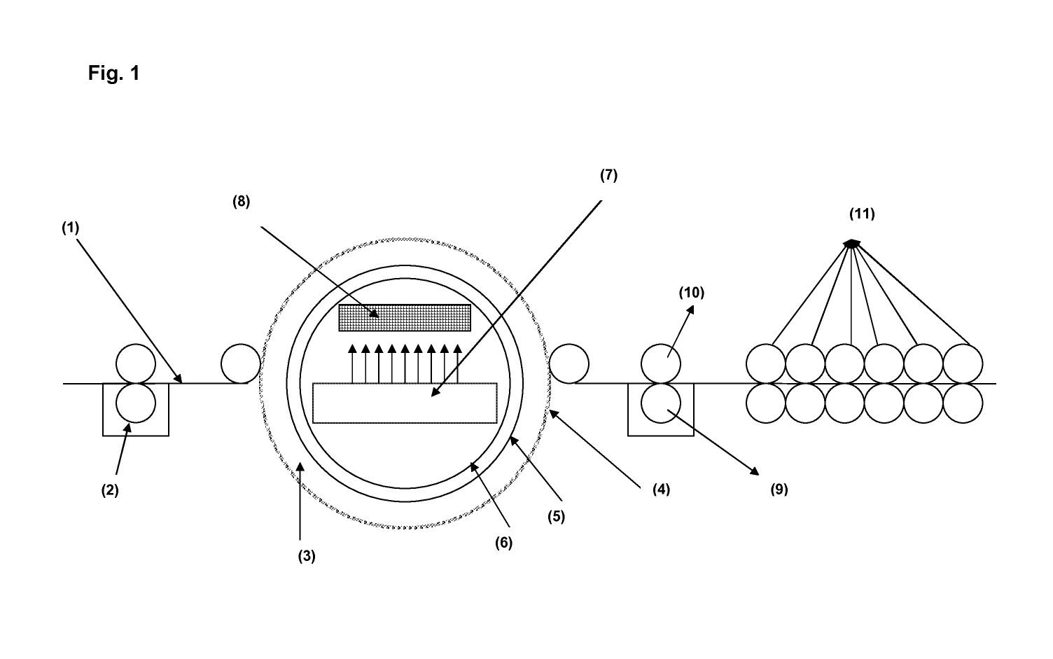

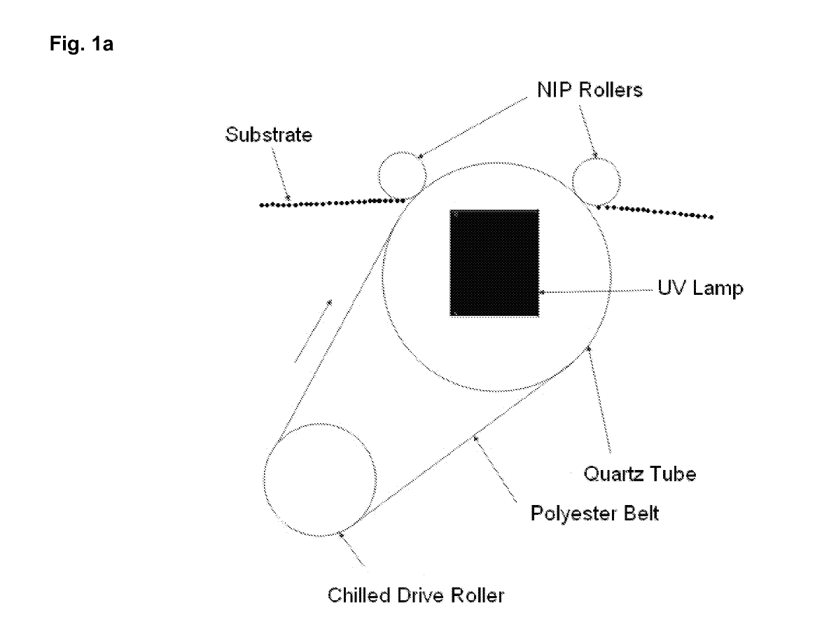

FIG. 1 is a schematic representation of a process for creating an optically variable image in accordance with the present invention using direct ultraviolet curable lacquer over-printed with metallic ink; and

FIG. 1a shows a belt system comprising a quartz tube having an UV lamp mounted inside, a chilled drive roller and a silicone-polyester belt containing the holographic image.

### EXAMPLE 1

### Direct Ultra Violet Curable Holographic Print Over-Printed with Specially Formulated Metallic Ink (Film)

Referring to FIG. 1, paper, aluminium, or another opaque substrates (1) is printed with an ultra violet curable lacquer (2) on its lower surface. An optically variable device or other lens or engraved structure is cast (3) into the surface of the lacquer (2) with the duplicated shim of the present invention (4) having the optically variable device or other lens or engraved structure thereon. The optically variable device or other lens or engraved structure image is imparted into the lacquer and instantly cured (6) via an UV lamp disposed through the shim (4) at normal processing speeds through polarizing lens (8), quartz roller (6), and clear polycarbonate roller (5). The optically variable device or other lens or engraved structure image is a facsimile of the image on the clear shim. Metallic ink (9) is printed (10) over the optically variable device or other lens or engraved structure and causes the optically variable device or other lens or engraved structure to become light reflective. Further colours (11) can be subsequently conventionally printed in-line at normal printing process speeds.

In an alternative embodiment, the paper, aluminium, and all manner of other opaque substrate (1) is replaced with a filmic substrate. Such material is substantially transparent and therefore the image is visible from both sides of the surface.

Instead of the optically variable image forming means shown in FIG. 1 (a transparent cylinder of quartz comprising a transparent plastic material carrying the optically variable image to be applied) a belt system as shown in FIG. 1a can be used.

The belt system comprises a quartz tube having an UV lamp mounted inside, a chilled drive roller and a polyester belt containing the holographic image (duplicated shim of the present invention). The silicone-polyester belt circulates around the quartz tube and the chilled drive roller.

A paper, aluminium, or another opaque substrates is printed with an ultra violet curable lacquer on its lower surface. The optically variable image is imparted into the lacquer by using the silicone-polyester belt, wherein nip rollers are used to ensure sufficient contact between the silicone-polyester belt and the lacquer coated substrate.

A further embodiment of the present invention is directed to an apparatus for forming a (security) product comprising a printing press and optically variable image forming means, wherein the optically variable image forming means comprise the duplicated shim according to present invention as well as a method for forming an optically variable image on a substrate comprising the steps of:

A) applying a curable varnish to at least a portion of the substrate;
B) contacting at least a portion of the varnish with optically variable image forming means;
C) curing the varnish and
D) optionally depositing a metallic ink on at least a portion of the cured varnish, wherein the optically variable image forming means comprise the duplicated shim according to the present invention. The structure of such an apparatus and the method for forming an optically variable image on a substrate is described in more detail in WO05/051675 and WO08/061,930.

Examples of an optically variable image or device are holograms or diffraction gratings, moire grating, etc. These optical microstructured images are composed of a series of structured surfaces. These surfaces may have straight or curved profiles, with constant or random spacing, and may even vary from microns to millimetres in dimension. Patterns may be circular, linear, or have no uniform pattern. For example a Fresnel lens has a microstructured surface on one side and a pano surface on the other. The microstructured surface consists of a series of grooves with changing slope angles as the distance from the optical axis increases. The draft facets located between the slope facets usually do not affect the optical performance of the Fresnel lens.
A positive Fresnel lens can be designed as a collimator, collector or with finite conjugates. These lenses are usually corrected for spherical aberration. They can also be coated for use as a second surface reflector.
A negative Fresnel lens is the opposite of a positive lens with diverging light rays. They can be coated for use as a first surface reflector.
A Fresnel cylindrical lens has a linear Fresnel structure. It collects light in one direction and the result is a line image instead of a point image.
Lenticular have linear structures where every groove has a small radius creating multiple line images. Lenticular are primarily used for projection screen and printed three-dimensional images.

Besides various diffraction grating structures like, holograms, kinegrams, direct write etc. other structures which may be included to augment these.
Images which are ‘hidden’ in a plane grating structure (Hidden Indicia) which looks to the naked eye like a matt area or lens structure. Information which is embedded in the structure can be text (a date or alpha numeric code) a logo or portrait which can be revealed by shining a laser pen through the image and projecting the information or images in real time.
A well established system, these are planar gratings prepared by means of a precision ruling engine with a diamond cutting tool. Gratings can be ruled on a variety of substrates; for example, glass, metal and ceramic. Groove density ranges from 20 to 1899 grooves/mm. For example the Ramsden wood gratings are equidistant circular grooves which are 1.700.000 of an inch apart, and formed the basis for the first diffraction pattern films and stamping foils.
Planar gratings with finely spaced grooves used at glancing angles in order to diffract UV light (UV, VUV, FUV and EUV) and soft X-rays.
Aberration corrected holographic, curved gratings minimize optical aberrations, such as coma, in grating-based systems. These are essential components in simple, compact, high-throughput spectrographs and monochromators, and diffraction systems employing fibre optics or solid state array detectors, or both.
One way to achieve very short l.a.s.e.r. light pulses is to use a pair of special planar diffraction gratings to compress the duration of the pulse. Gratings are made of thermally stable, temperature resistant materials to withstand intense l.a.s.e.r. light. Ultra short l.a.s.e.r. pulses are mainly used in research of fast transient phenomena.
The optically variable image can also be a zero-order diffractive microstructure having special colour effects—for example, colour change upon tilting and/or rotation. The use of zero-order diffractive microstructure as security devices in a variety of applications like banknotes, credit cards, passports, tickets, document security, anti-counterfeiting, brand protection and the like is known.

The possibility of counterfeiting decreased further by adding thermo- or photochromic dyes, UV/IR fluorescent dyes, magnetic stripes etc. into the OVD primer or ink.

The products obtained by the process of the present invention are new.

Accordingly, the present invention relates also to a (decorative, or security) product obtainable using the method according to the present invention.

In preferred embodiment of the present invention the (decorative, or security) product is based on paper, aluminium, or another opaque substrate.

The security product is preferably a banknote, passport, credit card, identification card, drivers license, compact disc or packaging.

Various features and aspects of the present invention are illustrated further in the examples that follow. While these examples are presented to show one skilled in the art how to operate within the scope of this invention, they are not to serve as a limitation on the scope of the invention where such scope is only defined in the claims. Unless otherwise indicated in the following examples and elsewhere in the specification and claims, all parts and percentages are by weight, temperatures are in degrees centigrade and pressures are at or near atmospheric.

### EXAMPLES

Formulations

Formulation 1 (without Aminoacrylate)

| Weight | Product | Description | Supplier |
|---|---|---|---|
| 35 | Ebecryl 605 | Bisphenol A epoxyacrylate | Cytec |
| | | diluted with 25% of TPGDA | |
| 10 | Ebecryl 40 | propoxylated/ethoxylated | Cytec |
| | | pentaerythritol tetraacrylate | |
| 30 | OTA 480 | propoxylated glycerol | Cytec |
| | | triacrylate | |
| 24 | TPGDA | tripropyleneglycol diacrylate | Cytec |
| 0.5 | Ebecryl 1360 | silicone hexaacrylate | Cytec |
| 0.5 | Dow Corning 57 | silicone additive | Dow |
| | | | Corning |
| 2.5 | 4-phenylbenzo- | Photoinitiator | Rahn |
| | phenone | | |
| 2.5 | Esacure KIP 150 | Photoinitiator | Lamberti |

Formulation 1 is applied using a 6 μm thick wirewound bar coater onto a corona treated PMX foil and laminated with the original shim under a pressure of 1 kg. The sample is exposed to a medium pressure mercury lamp through the transparent foil at different belt speeds and different lamp outputs to modify the light dose. The cured duplicated shim is afterwards separated from the original shim.

Chemical modifications resulting from acrylate crosslinking are monitored by IR spectroscopy with an ATR unit for surface measurements (Digital FTIR Excalibur Spectrometer FTS 3000 MX). The reaction of the acrylate double bonds is determined quantitatively by monitoring the disappearance of the IR band at 1410 cm⁻¹ characteristic of the acrylate double bond. A clean UV curable varnish is applied onto a corona treated plastic foil and embossed by the duplicated shim, while simultaneously exposed to UV light. Quality is evaluated using a ranking providing the surface of duplicated shim and varnish sticking together:

Surface sticking together

| | 0% | 5% | 50% | 75% | 95% | 100% |
|---|---|---|---|---|---|---|
| Ranking | 0 | 1 | 2 | 3 | 4 | 5 |

| Curing conditions | Acrylate conversion 1410 cm⁻¹ | Ranking |
|---|---|---|
| 200 W/cm, 10 m/min | 100% | 0 |
| 200 W/cm, 20 m/min | 94% | 2 |

Formulation 2 (without Aminoacrylate+20% TMPTA)

| Weight | Product | Description | Supplier |
|---|---|---|---|
| 35 | Ebecryl 605 | Bisphenol A epoxyacrylate | Cytec |
| | | diluted with 25% of TPGDA | |
| 10 | Ebecryl 40 | propoxylated/ethoxylated | Cytec |
| | | pentaerythritol tetraacrylate | |
| 30 | OTA 480 | propoxylated glycerol | Cytec |
| | | triacrylate | |
| 24 | TPGDA | tripropyleneglycol diacrylate | Cytec |
| 20 | TMPTA | trimethylolpropane triacrylate | Cytec |
| 0.5 | Ebecryl 1360 | silicone hexaacrylate | Cytec |
| 0.5 | Dow Corning 57 | silicone additive | Dow |
| | | | Corning |
| 2.5 | 4-phenylbenzo- | Photoinitiator | Rahn |
| | phenone | | |
| 2.5 | Esacure KIP 150 | Photoinitiator | Lamberti |

Formulation 2 is applied using a 6 μm thick wirewound bar coater onto a corona treated PMX foil and laminated with the original shim under a pressure of 1 kg. The sample is exposed to a medium pressure mercury lamp through the transparent foil at different belt speeds and different lamp outputs to modify the light dose. The cured duplicated shim is afterwards separated from the original shim.

Chemical modifications resulting from acrylate crosslinking are monitored by IR spectroscopy with an ATR unit for surface measurements (Digital FTIR Excalibur Spectrometer FTS 3000 MX). The reaction of the acrylate double bonds is determined quantitatively by monitoring the disappearance of the IR band at 1410 cm⁻¹ characteristic of the acrylate double bond.

A clean UV curable varnish is applied onto a corona treated plastic foil and embossed by the duplicated shim, while simultaneously exposed to UV light.

| Curing conditions | Acrylate conversion 1410 cm⁻¹ | Ranking |
|---|---|---|
| 200 W/cm, 10 m/min | 95% | 0 |
| 200 W/cm, 20 m/min | 92% | 3 |
| 200 W/cm, 30 m/min | 89% | 5 |
| 200 W/cm, 40 m/min | 72% | 5 |

Formulation 3 (with Aminoacrylate)

| Weight | Product | Description | Supplier |
|---|---|---|---|
| 30 | Ebecryl 605 | Bisphenol A epoxyacrylate | Cytec |
| | | diluted with 25% of TPGDA | |
| 10 | Ebecryl 7100 | amine modified acrylate | Cytec |
| 5 | Ebecryl 40 | propoxylated/ethoxylated | Cytec |
| | | pentaerythritol tetraacrylate | |
| 30 | OTA 480 | propoxylated glycerol | Cytec |
| | | triacrylate | |
| 24 | TPGDA | tripropyleneglycol diacrylate | Cytec |
| 0.5 | Ebecryl 1360 | silicone hexaacrylate | Cytec |
| 0.5 | Dow Corning 57 | silicone additive | Dow |
| | | | Corning |
| 2.5 | 4-phenylbenzo- | Photoinitiator | Rahn |
| | phenone | | |
| 2.5 | Esacure KIP 150 | Photoinitiator | Lamberti |

Formulation 3 is applied using a 6 μm thick wirewound bar coater onto a corona treated PMX foil and laminated with the original shim under a pressure of 1 kg. The sample is exposed to a medium pressure mercury lamp through the transparent foil at different belt speeds and different lamp outputs to modify the light dose. The cured duplicated shim is afterwards separated from the original shim.

Chemical modifications resulting from acrylate crosslinking are monitored by IR spectroscopy with an ATR unit for surface measurements (Digital FTIR Excalibur Spectrometer FTS 3000 MX). The reaction of the acrylate double bonds is determined quantitatively by monitoring the disappearance of the IR band at 1410 cm⁻¹ characteristic of the acrylate double bond.

A clean UV curable varnish is applied onto a corona treated plastic foil and embossed by the duplicated shim, while simultaneously exposed to UV light.

| Curing conditions | Acrylate conversion 1410 cm⁻¹ | Ranking |
|---|---|---|
| 200 W/cm, 10 m/min | 100% | 0 |
| 200 W/cm, 20 m/min | 98% | 1 |
| 200 W/cm, 30 m/min | 94% | 5 |

Formulation 4 (with Aminoacrylate+30% TMPTA)

| Weight | Product | Description | Supplier |
|---|---|---|---|
| 30 | Ebecryl 605 | Bisphenol A epoxyacrylate | Cytec |
| | | diluted with 25% of TPGDA | |
| 10 | Ebecryl 7100 | amine modified acrylate | Cytec |
| 5 | Ebecryl 40 | propoxylated/ethoxylated | Cytec |
| | | pentaerythritol tetraacrylate | |
| 30 | OTA 480 | propoxylated glycerol | Cytec |
| | | triacrylate | |
| 24 | TPGDA | tripropyleneglycol diacrylate | Cytec |
| 30 | TMPTA | trimethylolpropane triacrylate | Cytec |
| 0.5 | Ebecryl 1360 | silicone hexaacrylate | Cytec |
| 0.5 | Dow Corning 57 | silicone additive | Dow |
| | | | Corning |
| 2.5 | 4-phenylbenzo- | Photoinitiator | Rahn |
| | phenone | | |
| 2.5 | Esacure KIP 150 | Photoinitiator | Lamberti |

Formulation 4 is applied using a 6 μm thick wirewound bar coater onto a corona treated PMX foil and laminated with the original shim under a pressure of 1 kg. The sample is exposed to a medium pressure mercury lamp through the transparent foil at different belt speeds and different lamp outputs to modify the light dose. The cured duplicated shim is afterwards separated from the original shim.

Chemical modifications resulting from acrylate crosslinking are monitored by IR spectroscopy with an ATR unit for surface measurements (Digital FTIR Excalibur Spectrometer FTS 3000 MX). The reaction of the acrylate double bonds is determined quantitatively by monitoring the disappearance of the IR band at 1410 cm⁻¹ characteristic of the acrylate double bond. Duplicated shim is afterwards used to print holograms by UV according to patent II/2-23569.

| Curing conditions | Acrylate conversion 1410 cm⁻¹ | Ranking |
|---|---|---|
| 200 W/cm, 10 m/min | 99% | 0 |
| 200 W/cm, 20 m/min | 93% | 3 |

1. An UV-curable composition having sufficient concentration of UV-reactive functions for use in the production of a duplicated shim, wherein the duplicated shim shows, once cured, a sufficient crosslinking density and polymerization degree higher than 95% (measured by ATR spectroscopy by following the disappearance of the acrylate band at 1410 cm⁻¹).

2. The UV-curable composition according to claim 1, wherein UV-curable composition is an acrylate formulation having a concentration of 5 mol double bonds by kg of formulation.

3. The UV-curable composition according to claim 1, wherein the duplicated shim shows, once cured, a polymerization degree higher than 97%.

4. The UV-curable composition according to claim 1, comprising a silicone and/or fluorine containing compound.

5. A method for producing a duplicated shim comprising the following steps:
(a) coating at least part of a filmic substrate with the UV-curable composition (ultra violet curable lacquer) according to claim 1 on its upper surface,
(b) casting (transferring) an optically variable image into at least part of the surface of the UV-curable composition with an original shim having the optically variable image thereon,
(c) imparting the optically variable image into the UV-curable composition and instantly curing; via a UV lamp, or electron beam radiation to produce the duplicated shim;
(d) separating the duplicated shim from the original shim,
whereby in case the substrate is a cylinder the duplicated shim is obtained; and
in case the substrate is a sheet of a plastic material the sheet of a plastic material is processed to the duplicated shim.

6. The method according to claim 5, wherein the processing to the duplicated shim involves mounting the sheet of a plastic material to a cylinder, or forming a belt system comprising a quartz tube having an UV lamp mounted inside, a chilled drive roller and a belt of the sheet of the plastic material.

7. A duplicated shim, obtained by the method of claim 5.

8. An apparatus for forming a security product comprising a printing press and optically variable image forming means, wherein the optically variable image forming means comprise the duplicated shim according to claim 7.

9. A method for forming an optically variable image on a substrate comprising the steps of:
A) applying a curable varnish to at least a portion of the substrate;
B) contacting at least a portion of the varnish with optically variable image forming means;
C) curing the varnish and
D) optionally depositing a metallic ink on at least a portion of the cured varnish, wherein the optically variable image forming means comprise the duplicated shim according to claim 7.

10. The method according to 9, comprising the steps of:
A) printing an ultra violet curable varnish to at least a portion of a paper, aluminium, or another opaque substrate,
B) contacting at least a portion of the varnish with optically variable image forming means, wherein an optically variable device or other lens or engraved structure is cast into the surface of the lacquer with the duplicated shim, wherein the processing to the duplicated shim involves mounting the sheet of a plastic material to a cylinder, or forming a belt system comprising a quartz tube having an UV lamp mounted inside, a chilled drive roller and a belt of the sheet of the plastic\material having the optically variable device or other lens or engraved structure thereon;
C) curing the varnish via an UV lamp,
D) depositing a metallic ink on at least a portion of the cured varnish, and
E) optionally printing further colours.

11. The method according to 9, comprising the steps of:
A) printing an ultra violet curable varnish to at least a portion of a transparent filmic substrate,
B) contacting at least a portion of the varnish with optically variable image forming means, wherein an optically variable device or other lens or engraved structure is cast into the surface of the lacquer with the duplicated shim, wherein the processing to the duplicated shim involves mounting the sheet of a plastic material to a cylinder, or forming a belt system comprising a quartz tube having an UV lamp mounted inside, a chilled drive roller and a belt of the sheet of the plastic\material having the optically variable device or other lens or engraved structure thereon;
C) curing the varnish via an UV lamp,
D) depositing a metallic ink on at least a portion of the cured varnish, and
E) optionally printing further colours.

12. A security product obtainable by using the method according to claim 9.

13. The product according to claim 12, which is a banknote, passport, credit card, identification card, drivers license, compact disc or packaging.

14. Optically variable image forming means, comprising the duplicated shim according to claim 7.

15. Optically variable image forming means according to claim 14, wherein
the duplicated shim is a cylinder comprising the cured UV-curable composition carrying the optically variable image; or the duplicated shim is a cylinder comprising a sheet of a plastic material comprising the cured UV-curable composition carrying the optically variable image; or
the duplicated shim is a belt system comprising a quartz tube having an UV lamp mounted inside, a chilled drive roller and a belt of a plastic material comprising the cured UV-curable composition carrying the optically variable image.
